(19) United States
(12) Patent Application Publication
(10) Pub. No.: US 2018/0015358 A1
(43) Pub. Date: Jan. 18, 2018

(54) GAMING ELEMENTS, SYSTEMS AND METHODS

(71) Applicant: David Mahon, Las Vegas, NV (US)

(72) Inventor: David Mahon, Las Vegas, NV (US)

(21) Appl. No.: 15/716,844

(22) Filed: Sep. 27, 2017

Related U.S. Application Data
(63) Continuation-in-part of application No. 15/067,022, filed on Mar. 10, 2016, now abandoned.
Application No. 15/067,022 is a continuation of application No. 13/083,408, filed on Apr. 8, 2011, now abandoned.
Application No. 13/083,408 is a continuation-in-part of application No. 12/776,273, filed on May 7, 2010, now abandoned.
Application No. 12/776,273 is a continuation-in-part of application No. 15/693,746, filed on Sep. 1, 2017.

(51) Int. Cl. A63F 1/18; A63F 3/00; G07F 17/32

(52) U.S. Cl. CPC A63F 1/18; G07F 17/3293; A63F 3/00157; G07F 17/32; G07F 17/329

(57) ABSTRACT

A method initiates execution of a wagering event uses playing card symbols comprising:
providing a set of randomized playing cards comprising five distinct sets of face-colored playing cards, each set having numeric values evenly distributed among the sets of 1, 2, 3, 4, 5, 6, 7, 8, 9, 10 and 11, with one of the five distinct sets valued as negative numeric values;
delivering two random playing cards to each of a player position hand as an initial player position hand and a banker position hand as an initial banker position hand;
summing respective numeric values of the two cards in each of the player position hand and the banker position hand, including any negative numeric values;
determining if there is a concluding outcome in a comparison of respective summed numeric values in the player position hand and the banker position hand.

### RELATED APPLICATIONS DATA

This application claims priority under 35 USC 120 as a Continuation-in-Part to U.S. application Ser. No. 15/693,746, filed 1 Sep. 2017 Titled GAMING ELEMENTS, SYSTEMS AND METHODS, which in turn claims priority as a Continuation in Part of U.S. patent application Ser. No. 15/067,022, filed 3 Mar. 2016, Titled GAMING ELEMENTS, SYSTEMS AND METHODS, which in turn claims priority under 35 USC 120 as a Continuation of U.S. patent application Ser. No. 12/776,273, filed 7 May 2010, Titled GAMING ELEMENTS, SYSTEMS AND METHODS, which in turn claims priority under 35 USC 120 as a Continuation of U.S. patent application Ser. No. 13/083,408, filed 11 Apr. 2011, titled GAMING ELEMENTS, SYSTEMS AND METHODS, which in turn claims priority under 35 USC 120 as a Continuation-in-Part of U.S. patent application Ser. No. 12/776,273, filed 7 May 2010, titled GAMING ELEMENTS, SYSTEMS AND METHODS, which in turn claims priority from U.S. Provisional Patent Applications Ser. Nos. 61/215,684; 61/215,695 and 61/215,708, all three filed On 7 May 2009, and all three titled GAMING ELEMENTS, SYSTEMS AND METHODS.

### BACKGROUND OF THE INVENTION

The invention generally relates to games and more particularly to wagering games and method of playing wagering games.

For example Bingo is a game in which players purchase at least one printed or electronic 5×5 matrix card having numbers thereon. The bingo cards contain twenty-five spaces delineated by five vertical columns and five horizontal rows. Each space in the grid contains a number, except for the center square, which is often filled or marked “free.” The highest number generally used is 75. The letters B I N G O are printed above the five vertical columns. The printed numbers are limited as 1-15 in the B column, 16-30 in the I column, 31-45 in the N column, 46-60 in the G column and 61-75 in the O column.

Random numbers are then drawn and players match those numbers to those appearing on the 5×5 card. These numbers are generally located on color balls. The first player to have a card where the drawn numbers form a specified pattern i9s the winner. The winner typically yells out “Bingo!” to notify others and inform the caller of the win. Before the prize is distributed to the winner, the card is properly checked for accuracy before the win is officially confirmed at which time the prize is secured and a new game begun. Many games require “Bingo!” to be called before the next ball.

### SUMMARY OF THE INVENTION

In some embodiments, the invention is directed to a device for playing games, which includes a plurality of game elements, wherein each game element is associated with a plurality of features, each feature of the plurality of features being selected from a discrete category of features, each game element including a feature from each discrete category of features, whereby the plurality of game elements are capable of being arranged into a plurality of subsets of game elements by features within the discrete category of features, wherein the discrete categories of features are selected from the group consisting of colors, alphabetic characters, ideographic characters and numerical values.

In some embodiments, the game elements may be playing cards, game tiles or virtual representations of cards.

In some embodiments, each game element includes a color, and alphabetic character and a numerical value. The game elements may be of different colors and each subset of game elements of different colors may include the same set of alphabetic characters and numerical values.

In some embodiments, the invention is directed to a method of playing a game, which includes the steps of: accepting a player to participate in the game; providing a plurality of game elements to the participating player to form a player hand, wherein each game element is associated with a plurality of features, each feature of the plurality of features being selected from a discrete category of features, each game element including a feature from each discrete category of features, whereby the plurality of game elements are capable of being arranged into a plurality of unique subsets of game elements by features within the discrete category of features; comparing the game elements forming the player hand with predefined criteria, wherein the predefined criteria relates to assigning a player hand ranking based on the features associated with the game elements forming the player hand and identifies a penalty condition associated with at least one feature of the plurality of features for which the player hand is automatically assigned a losing ranking; determining whether the player hand satisfies the predefined criteria relating to the penalty condition; determining whether the player hand satisfies the predefined criteria relating to a player hand ranking if the penalty condition is not satisfied by the player hand; and assigning a ranking to the player hand.

In some embodiments, the aforementioned method further includes the step of providing a payout amount to the player based on assigned player hand ranking.

In some embodiments, the step of accepting a player participating in the game in the aforementioned method further includes receiving a wager from the player.

In some embodiments, the plurality of game elements are randomly dealt to the participating player to form a player hand.

In some embodiments, the one or more categories of features comprise numeric values, alphabetic characters, colors, ideographic characters, symbols and graphics.

In some embodiments, the game elements are divisible into a plurality of subsets of game elements, whereby the game elements of each subset of the plurality include an exclusive feature from a sole category of features and the same combinations of the remaining features from other categories of features. In such embodiments, the penalty condition may be associated with one of the exclusive features.

In some embodiments, the aforementioned method further includes the steps of: receiving instructions from the participating player identifying game elements to be discarded from the player hand and providing the participating player with additional game elements to replace the game elements discarded.

In some embodiments, the penalty condition is associated with a feature, whereby a penalty subset of gaming elements associated with the penalty feature is identifiable and a player hand including a game element from the penalty subset will automatically be assigned a losing player hand ranking irrespective of the player hand ranking unless the player hand includes only game elements from the penalty subset.

In some embodiments, the invention is directed to an electronic gaming machine which includes an input device configured for accepting a player wager to participate in a bingo-poker hybrid game; a display configured for: displaying representations of bingo-poker hybrid cards; and a processor configured for randomly providing a plurality of representations of game cards to the participating player to form a player hand, wherein each game card is associated with a plurality of features, each featL11? of the plurality of features being selected from a discrete category of features, each game card including a feature from each discrete category of features, whereby the plurality of game cards are capable of being arranged into a plurality of unique subsets of game cards by features within the discrete category of features; comparing the game elements forming the player hand with predefined criteria, wherein the predefined criteria relates to assigning a player hand ranking based on the features associated with the game elements f01ming the player hand and identifies a penalty condition associated with at least one feature of the plurality of features for which the player hand is automatically assigned a losing ranking; determining whether the player hand satisfies the predefined criteria relating to the penalty condition; determining whether the player hand satisfies the predefined criteria relating to a player hand ranking if the penalty condition is not satisfied by the player hand; and assigning a ranking to the player hand. The aforementioned electronic gaming machine may further include an output device for providing a payout or credit if one of the predefined criteria is satisfied.

In some embodiments, the invention is directed to a device for playing games, which includes a plurality of game elements, wherein each game element is associated with a plurality of features, each feature of the plurality of features being selected from a discrete category of features, each game element including a feature from each discrete category of features, whereby the plurality of game elements are capable of being arranged into a plurality of subsets of game elements by features within the discrete category of features, wherein the discrete categories of features are selected from the group consisting of colors, alphabetic characters, ideographic characters and numerical values.

In some embodiments, the game elements may be playing cards, game tiles or virtual representations of cards.

In some embodiments, each game element includes a color and a numerical value. The game elements may be of different colors and each subset of game elements of different colors may include the same set of numerical values.

In some embodiments, the invention is directed to methods of playing games, such as those described herein and in the accompanying materials, with the game elements.

Some embodiments are directed to a device for playing games, comprising a plurality of game elements, wherein each game element is associated with a plurality of features, each feature of the plurality of features being selected from a discrete category of features, each game element including a feature from each discrete category of features, whereby the plurality of game elements are capable of being arranged into a plurality of subsets of game elements by features within the discrete category of features, wherein the discrete categories of features are selected from the group consisting of colors, alphabetic characters, ideographic characters and numerical values.

Some embodiments are directed to a method of playing a game, comprising the steps of: accepting a player to participate in the game; providing a plurality of game elements to the participating player to form a player hand, wherein each game element is associated with a plurality of features, each feature of the plurality of features being selected from a discrete category of features, each game element including a feature from each discrete category of features, whereby the plurality of game elements are capable of being arranged into a plurality of unique subsets of game elements by features within the discrete category of features; dealing at least a portion of the game elements into an initial condition according to a preset configuration; and receiving changes to the initial condition of the game elements dealt from one or more subsets by moving game elements within the preset configuration according to a first preset criteria; receiving changes to the initial condition of the game elements dealt from at least one subset by moving the game elements from the at least one subset according to a second preset criteria; comparing the condition of the game elements with a winning condition to determine whether the winning condition is satisfied. The step of accepting a player participating in the game further may comprise receiving a wager from the player.

Some embodiments are directed to an electronic gaming machine comprising: input device configured for receiving player instructions; a display configured for displaying representations of cards; a processor configured for: randomly providing a plurality of representations of game cards to the participating player to form a player hand, wherein each game card is associated with a plurality of features, each feature of the plurality of features being selected from a discrete category of features, each game card including a feature from each discrete category of features, whereby the plurality of game cards are capable of being arranged into a plurality of unique subsets of game cards by features within the discrete category of features; dealing at least a portion of the game elements into an initial condition according to a preset configuration; receiving changes to the initial condition of the game elements dealt from one or more subsets by moving game elements within the preset configuration according to a first preset criteria; receiving changes to the initial condition of the game elements dealt from at least one subset by moving the game elements from the at least one subset according to a second preset criteria; comparing the condition of the game elements with a winning condition to determine whether the winning condition is satisfied.

### BRIEF DESCRIPTION OF DRAWINGS

In the descriptions that follow, like parts are marked throughout the specification and drawings with the same numerals, respectively. The drawing figures are not necessarily drawn to scale and certain figures may be shown in exaggerated or generalized form in the interest of clarity and conciseness or for other reasons.

FIG. 1 illustrates a plurality of exemplary game elements configured in accordance with some embodiments the invention;

FIG. 2 is a flow diagram of an exemplary game play method in accordance with some embodiments of the invention which may be carried out by a dealer or through an automated system and uses the game elements shown in FIG. 1;

FIG. 3 is a flow diagram of another exemplary game play method in accordance with some embodiments of the invention which may be carried out by a dealer or through an automated system and uses the game elements shown in FIG. 1 ;

FIG. 4 depicts an exemplary 5×5 matrix sorted and randomly populated with the game elements shown in Fie. I in accordance with some embodiments of the invention;

FIG. 5 is an exemplary illustration showing a standard “Texas Hold'em” style poker table configured and adapted to include a center spaced 5×5 bingo matrix card (digital or paper-based) populated with the game elements shown in FIG. 1 in accordance with one aspect of the invention;

FIGS. 6A through 6C depict a flow diagram illustrating exemplary processes performed in the bingo-like game in accordance with an aspect of the invention;

FIG. 7 illustrates the exemplary 5×5 bingo matrix card populated after a first round of a game played in accordance with an aspect of the invention;

FIG. 8 illustrates the exemplary 5×5 bingo matrix card populated after the second round of a game played in accordance with an aspect of the invention;

FIG. 9 illustrates the exemplary 5×5 bingo matrix card populated after the third round of a game played in accordance with an aspect of the invention;

FIG. 10 depicts another embodiment of the exemplary 5×5 bingo matrix card populated after the first round of a game played in accordance with an aspect of the invention.

FIG. 11 depicts another embodiment of the exemplary 5×5 bingo matrix card populated after the first round of a game played in accordance with an aspect of the invention.

FIG. 12 depicts another embodiment of the exemplary 5×5 bingo matrix card populated after the first round of a game played in accordance with an aspect of the invention.

FIG. 13 illustrates a plurality of game elements.

FIGS. 14-20 illustrate exemplary game configurations and methods for playing games with game elements each in accordance with the present invention.

FIGS. 21A-21E provide flow diagrams exhibiting exemplary game play with game elements each in accordance with the present invention.

FIG. 22 illustrates a plurality of gaming elements in accordance with aspects of the invention.

FIG. 23 illustrates a plurality of gaming elements in accordance with aspects of the invention.

FIG. 24 illustrates an exemplary electronic gaming machine displaying slot games using game elements in accordance with the present invention.

FIGS. 25-29 illustrates an exemplary electronic gaming machine displaying poker type games using game elements in accordance with the present invention.

FIG. 30 illustrates exemplary hardware for electronic gaming machines, electronic tables and multiplayer platforms using gaming elements of the invention.

FIG. 31 illustrates a hand-held device useful for executing gaming events using the gaming elements of the present invention.

### DETAILED DESCRIPTION OF THE INVENTION

Some embodiments relate to a game device or game system having a plurality of game elements such as cards, tiles, tokens, and balls as well a virtual or graphical representations thereof, which may be configured and adapted for use in a variety of game methods.

The game elements may each include features which are selected from one or more discrete categories of features. For example, each game element may include a feature relating to a specific color, such as blue, red, purple, white, etc. Other features included on each game element may be selected from discrete categories such as numerical values, alphabetic characters, ideographic characters, pictographs, names, symbols graphics or any other indicia having a common attribute or connection that enables categorization thereof. It should be readily apparent that the game elements are not limited to any specific features or categories thereof.

In some embodiments, the game elements include similar combinations of features, including one or more identical features from one or more discrete categories. However, at least one feature on each game element is selected to differentiate game elements so that all game elements are unique and there are no fully identical game elements. For example, in some embodiments, the distinct features include integers and letters, and may include Flame elements having the same letters or integers or both. Additionally, the letters may be selected to form words or terms found in any language. For example, Chinese characters may be used instead. Game elements with matching features also have at least one distinct additional feature which distinguishes these game elements, such as color or symbol.

The distribution of features among game elements allows the game elements to be arranged into subsets of game elements that share a common attribute. For example, in some embodiments discussed in detail herein, the game elements may be separated into subsets of game elements having the same color, the same number and/or the same letter.

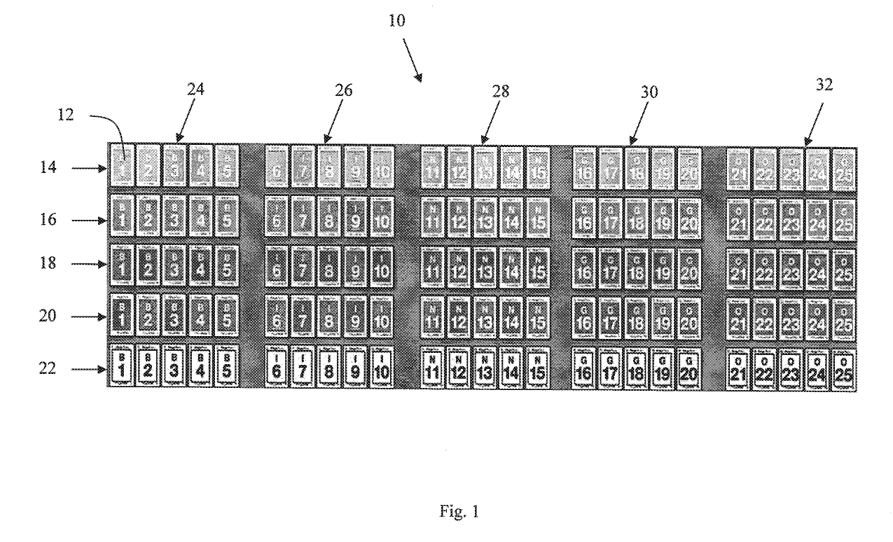

In an illustrative example shown in FIG. 1, a game device 10 includes game elements 12 which generally comprise a deck of cards but may also be considered as a virtual representation thereof. Deck 12 includes one hundred and twenty five cards having features which may be generally categorized as colors, letters and numbers. The colored gaming elements (e.g., orange, green, blue, purple and white or non-colored) are capable of being arranged into twenty-five card subsets identified by arrows 14, 16, 18, 20 and 22. Cards 12 in subsets 14 through 22 include combinations of letters (i.e., B, I, N, G and O) and integers from 1 to 25.

In this embodiment, each subset 14 through 22 may be further arranged into five subsets of 25 cards each based on letters, in that a subset 24 of cards numbered from 1 to 5 is associated with the letter “B”, a subset 26 of cards numbered from 6 to 10 is also associated with the letter “I”, a subset 28 of cards numbered from 11 to 15 is also associated with the letter “N”, a subset 32 of cards numbered from 16 to 20 is associated with the letter “G”, and a subset 34 of cards numbered from 21 to 25 is also associated with the letter “O”, among other things.

It should be understood that game device 10 is a non-limiting example of the many variations of a game device according to the invention, and other colors, letters or words and numbers may be employed in the spirit and scope of this invention. Wild cards may also be added to the game elements. In addition to game devices such as those described herein, the invention is also directed to game play methods that may utilize game devices according to the invention.

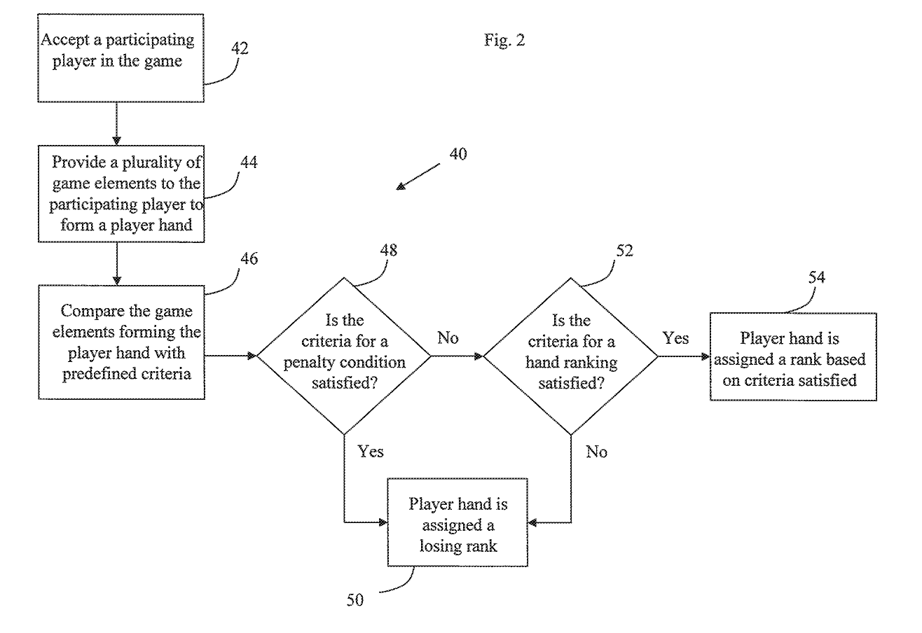

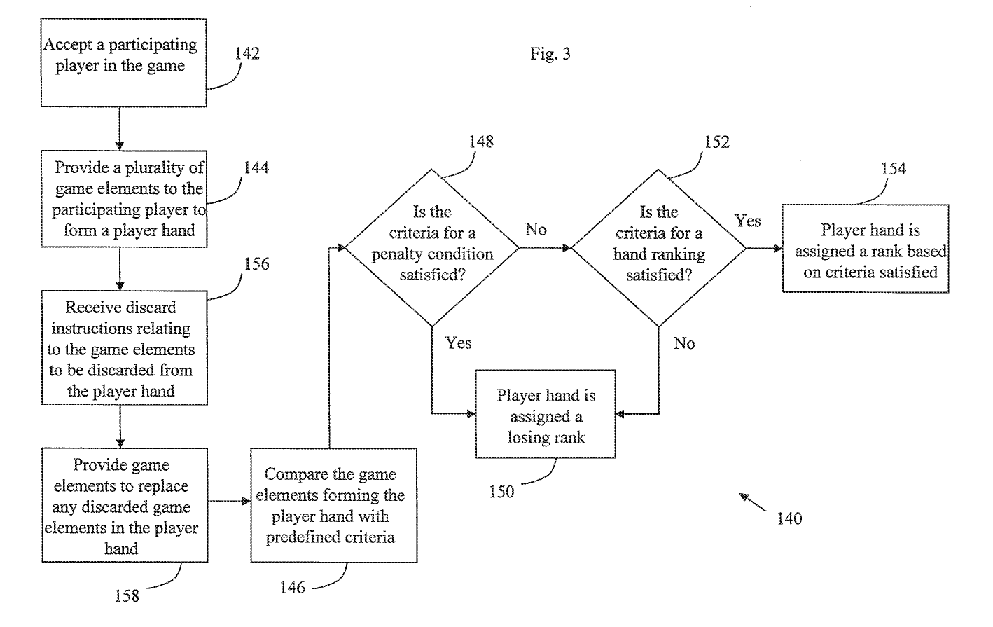

In some embodiments, a method 40 of playing a game according to the invention, such as game 10, includes various steps as shown in FIG. 2. It should be understood that the steps recited herein may be carried out in a variety of ways, such as by a dealer physically using game elements in a casino, via an electronic gaming machine (EGM) in a gaming establishment, through a computer or portable device, such as a mobile phone, capable of communicating via the Internet, global telecommunication network or world wide web.

In step 42, a player interested in participating in the game is accepted. It should be understood that the step of accepting the player may be manifested in a variety of ways depending on the particular embodiment, and may further comprise receiving player information or identification data or a wager. For example, if game 40 is played through an online network, a player may be accepted as participating in the game after submitting information or actuating an online link.

In step 44, a plurality of game elements are provided to the participating player to form a player hand. Again, this step may be manifested differently depending on the embodiment of the game according to the invention. For example, shuffled cards may be physically dealt by a dealer from a card shoe at a casino table to form the player hand, or virtual representations of the game elements may be randomly provided on a display of an EGM via a random number generator or from a pool of game elements.

In step 46, the game elements in the player hand is compared with predefined criteria. The predefined criteria includes information relating the features of game elements in the player hand to a one or more particular player hand rankings and information relating to a penalty condition. The penalty condition may be associated with the presence of one or more game elements in the player hand having a particular feature, such as a specific color of a game element or certain letter, or certain combination of features. For example, using the game device 10, the penalty condition may be associated with a player hand consisting of one or more game elements of a specific color but less than all game elements of that color, such as white, and less than a full hand of game elements with one or more other matching features, such as a player hand made up of game elements having all the same number or letter. It should be readily apparent that the penalty condition may be related to many different combinations of features that may be found in the game elements of the player hand. In alternative embodiments which include wild cards, the wild cards generally do not counteract the penalty condition.

If the predefined criteria relating to the penalty condition is satisfied in step 48, then the player hand is assigned a losing rank in step 50. Depending on the embodiment, the player may forfeit the game and/or lose some or all of any wagers placed in the game. If the predefined criteria relating to the penalty condition is not satisfied in step 48, then it is determined whether the predefined criteria relating to the player hand ranking is satisfied in step 52. The player hand ranking may comprise a pay table of rankings establishing a payout amount or award depending on the player hand achieved as measured by the presence, lack or combination of features associated with the game elements in the player hand. Alternatively, the presence, lack or combination of features associated with the game elements in the player hand may be used to assign a hand ranking that can be compared to the ranking of a dealer hand or the ranking of another player hand in the game.

If in step 52, the predefined criteria relating to player hand rankings is not satisfied, then the player hand is assigned a losing rank as shown in step 50, or the game otherwise ends in either a loss or tie, depending on the embodiment and/or presence of a competing dealer or player hand, determined. If a criterion of the predefined criteria relating to player hand rankings is satisfied in step 52, then the player hand is assigned the rank associated with the criteria or criterion satisfied in step 54. As previously mentioned, some embodiments may then involve comparing the predefined criteria with a paytable, other player hand or dealer hand to determine a payout amount, a game winner or outcome.

Game play method 40 partially resembles the game play of a “stud” poker-type game. Other game play methods using game device 10 or variations thereof are contemplated as being within the spirit and scope of the invention. For example, a game play method 140 resembles a “draw” poker-type game, in that step 156 involves receiving instructions relating to whether any game elements should be discarded from the player hand provided in step 144. Depending on the embodiment, such instructions may be received by a dealer, through an EGM input keypad or touchpad or data input/output device for example. In step 158, the player is provided with game elements to replace the discarded game elements, if any, in the same amount as the amount discarded. Unless further draw steps such as steps 156 and 158 are provided, the player hand is now in final form for comparison with the predefined criteria in step 158. As in method 40, if the predefined criteria relating to the penalty condition is satisfied in step 158, then the player hand is assigned a losing rank in step 150. In some embodiments, the penalty condition may be designated or selected, randomly or otherwise, during the play of the game.

In some embodiments, the penalty condition is preset or selected, designated or otherwise made known to the players prior to participating in the game. Thus, in such embodiments, players would likely opt to discard any game elements in step 156 that possess features that would trigger the penalty condition in step 158. However, as in draw poker-type games, players may also choose to retain or replace game elements in an effort to improve the odds of achieving a desirable player hand ranking, that is, assuming the ranking system is preset or made known to the players prior to the start of the game. It should be readily apparent that discarding game elements in an attempt to improve the hand ranking of an initial player hand provided in step 144 involves a strategic risk. In particular, an initial player hand that would not satisfy the penalty condition may be changed to a final player hand which satisfies the penalty condition, as a result of the game elements provided in step 158.

In some embodiments, game method 40 or 140 may be played with game device 10 as described above and with player hands comprising five cards. The rankings are generally based on obtaining the best set of five colored game elements in a row, also referred to as a “single line bingo.” Additional steps may be included in the method to enable payouts to players achieving certain player hand rankings as set forth by the predefined criteria. The penalty condition relates to receiving a white card, which spoils any bingo payline, that is, the ranking achieved by the other cards in the player hand is nullified. In some embodiments, players may place insurance wagers to hedge against being dealt a white card.

An exemplary paytable for a method such as game method 140 played on an EGM is shown below. The player hand rank assumes that no white color game element is present and the payout is expressed as a multiple of the wager received to participate in the game.

| Player hand rank * | Payout |
|---|---|
| Any pair (a pair of the same color game elements) | 0 |
| Two pair (a first pair the same color game elements and a second | 0 |
| pair of the same color game elements but a different color than | |
| the first pair) | |
| Three of a kind (three of the same color game elements | 1 |
| Full House (three game elements of the same color and two | 1 |
| game elements of the same color but a different color than the | |
| three game elements) | |
| Four of a kind (four of the same color game elements) | 2 |
| Flush (all five game elements having the same color) | 3 |

* With no white colored game element. Any white colored game element pays nothing.

In this embodiment, the predefined criteria may also enable bonus payouts associated with a player hand achieving a bonus ranking based on the presence of game elements possessing certain features. For example, bonuses may be paid on number and letter straights and combinations. An exemplary bonus paytable for a method such as game method 140 played on an EGM is shown below. The player hand column refers to the player hand containing the features described, such as the letters BINGO or a series of numbers, and the payout is expressed as a multiple of the wager received to participate in the game. In this embodiment, bonuses are paid on any five colored card bingo or any white card flushes or any quintuplet.

| Player hand | Payout |
|---|---|
| B-I-N-G-O (Any color combination excluding white) | 1 |
| Three number straight (Any color combination excluding white) | 1 |
| Four number straight (Any color combination excluding white) | 2 |
| Five number straight (Any color combination excluding white) | 7 |
| Five white cards (Any numbers) | 10 |
| B-I-N-G-O (Any flush of all the same color) | 15 |
| Any Letter Flush (all the same letters) | 20 |
| Triplicates (three game elements having the same letter and | 5 |
| same number, with no white game element) | |
| Quadruplicates (four game elements having the same letter | 50 |
| and same number, with no white game element) | |
| Quintuplets (five game elements having the same letter and | 200 |
| same number) | |
| Three number straight (Any flush) | 50 |
| Four number straight (Any flush) | 250 |
| Five number straight (Any flush) | 1000 |
| Royal Flush (Any flush with numbers 21 through 25) | 2000 |

As can be seen by viewing the game elements 12, more than one bonus and player hand ranking may be achieved naturally based on the configuration of game device 10. For example, a royal flush will satisfy the predefined criteria for the any letter flush bonus and flush player hand ranking payouts. It should be understood that the tables above are merely illustrative and may be adjusted depending on the desired house advantage.

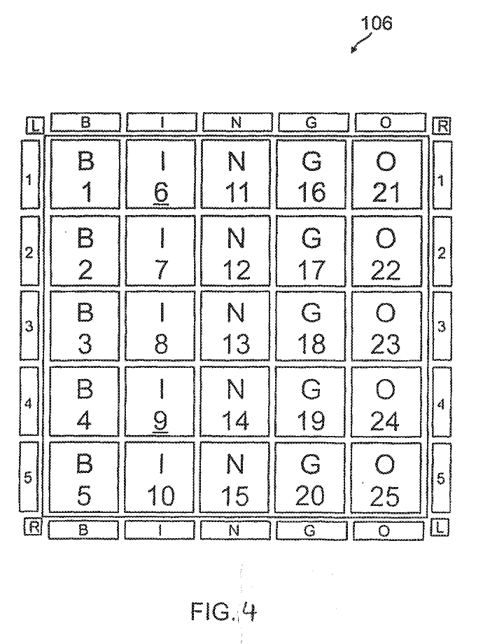

In some embodiments, a game method incorporating game elements 12 is configured and adapted for use in a reel slot-type format having five mechanical or virtual reels. The game elements are sorted amongst the reels by letter to spell the word BINGO as shown by the 5×5 matrix 106 in FIG. 4. Thus, the “B” reel strip is restricted to a randomized arrangement of game elements of every color in a number range from 1 to 5 only. Likewise, the “I” reel strip contains game elements of every color in a number range from 6-10, the “N” reel strip contains game elements of every color in a number range from 11-15, the “G” reel strip contains game elements of every color in a number range from 16-20 and the “O” reel strip contains game elements of every color in a number range from 21-25. The reel strips may each include one or more subsets of twenty-five game elements depending on the odds desired. The reel may include any number of paylines and may be provided in a variety of matrix sizes, such as 3×5, 4×5 or 5×5.

The game plays similarly to a slot machine in that the reels either physically spin or appear to spin randomly. When the spinning is completed, the reels stop and the paylines wagered upon are shown as lines disposed over the matrix of stopped game elements. Some paylines are disposed straight across each row of the matrix while others extend diagonally to move up or down rows while crossing over at least one game element in each column. In this embodiment, the paylines will cross over five game elements on the matrix. In the case of a 5×5 matrix, a plurality of paylines may be employed, such as fully diagonal paylines and paylines which extend only along a column.

Payouts are based on the paylines including game elements having features which meet the predefined criteria. The predefined criteria may be based on the amount of matching colors associated with the game elements on each payline. For example, a payline consisting of five game elements wherein three of the game elements have the same color and the remaining two game elements have a different color may payout a multiple of the original wager as a three of a kind. Various payouts may be established based on the odds of achieving certain combinations of features.

As in the previous embodiments, the predefined criteria includes a penalty condition. In some embodiments, the penalty condition relates to the presence of a white colored game element on a payline such that one or more white colored game elements on a payline results in a loss of a portion or all of the wager on that payline, irrespective of the other game elements in the payline.

Other embodiments describe further alternative games of the invention in which the game includes bingo and poker like elements and uses game elements 12.

In some embodiments of games according to the invention, the white color game elements are provided in the form a 5×5 matrix sorted by letter to spell the word BINGO as shown by matrix 106 in FIG. 4. Thus, when using game elements 12, the white color game elements in each column contain a restricted distribution of features, that is, restricted to a randomized arrangement of numbers within a particular range. For example, the “B” column is restricted to a randomized arrangement of numbers from 1 to 5 only. Likewise, the white color game elements in the “I” column contain a restricted distribution of features are randomized numbers 6-10, the white color game elements in the “N” column contain a restricted distribution of features are randomized numbers 11-15, the white color game elements in the “G” column contain a restricted distribution of features are randomized numbers 16-20, and the white color game elements in the “O” column contain a restricted distribution of features are randomized numbers 21-25.

Many games may be played using matrix 106. For example, one or more players may be dealt a hand of cards to play directly against the house, either against a dealer hand or predefined criteria such as a paytable rankings, wherein the relative rankings may be based on the most five card bingos achieved and/or highest value five card bingos achieved. Alternatively, one or more players may play a game in which the players receive a partial hand and community cards are dealt, wherein each final player hand is composed of the player's partial hand and community cards and the ranking is based on the most five card bingos and/or highest value five card bingos achieved.

It should be understood that different size matrixes may be employed for different games in accordance with the invention. For example, a 3×3 matrix in which bingo hands are based on three cards may be an option to change the dynamics of the game,

It should also be understood that the game may be played without a matrix, wherein the best or highest ranking player hand wins either against other players, a dealer hand or in comparison with a predefined criteria such as a paytable listing hand rankings and payouts. For example, a game may be played in which three card, five card or seven card hands may be dealt to each player. The game may be played similar to stud poker or include a draw step as described in previous embodiments. Further embodiments may include a dealer and/or player qualification step in which a hand must be of at least a certain ranking to reach a final outcome or payout. It should be readily apparent that game elements as described herein are easily adaptable to form unique variations or alternatives to other wagering games, such as roulette, blackjack, while also adding new characteristics thereto, such as a penalty condition.

In one game which may be considered a variation of Texas Hold'em poker, a partial player hand of game elements is provided to a player. Additional cards are then dealt for use with the partial player hand to form a final complete hand. As in Texas Hold'em poker, multiple portions of the community cards may be systematically dealt or revealed similar to the flop, turn and river. In some embodiments, the partial player hand consists of three game elements and the community cards consist of twenty one game elements, shown in portions of seven game elements at one time.

The game progresses by marking the cell on matrix 106 that corresponds to the letter and number of the game element with the color of the game element. The marks are placed on matrix 106 as the game elements are received or revealed, much like in traditional bingo, with the ultimate goal being to obtain as many bingo paylines as possible. Bingo paylines on matrix 106 consist of five colored cells and can be generated either through straight, vertical, or diagonal lines. Nonetheless, different bingo patterns can be used. These patterns can be chosen by the players, dealer, or randomly. The partial player hand or “hole” cards may be marked on corresponding cells of matrix 106 by a colored diamond, circle or other means for identifying it as a hole card and corresponding to the color of the hole card. Game elements that provide duplicate numbers shown on matrix 106 may be indicated by dividing the corresponding cell on matrix 106 into colored portions corresponding to the color of the game elements. For example, if orange and blue game elements associated with the number 17 are received then the corresponding cell in matrix 106 may be colored half blue and half orange.

The aforementioned game may be incorporated in an EGM and provide payouts depending on the amount of bingo paylines achieved and provide a bonus based on flush bingos, that is, a bingo payline in which the same colors have been marked off as described above. For example, a result of 5 total bingo paylines may pay 100 to 1, and if 2 of those bingo paylines are all the same color, then a bonus of 500 to 1 is added.

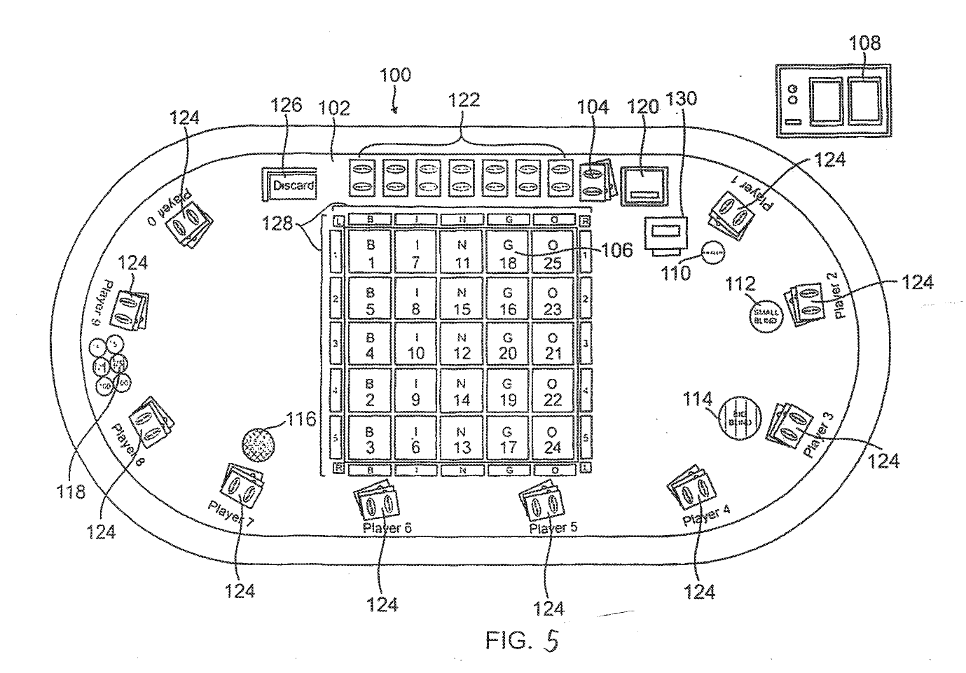

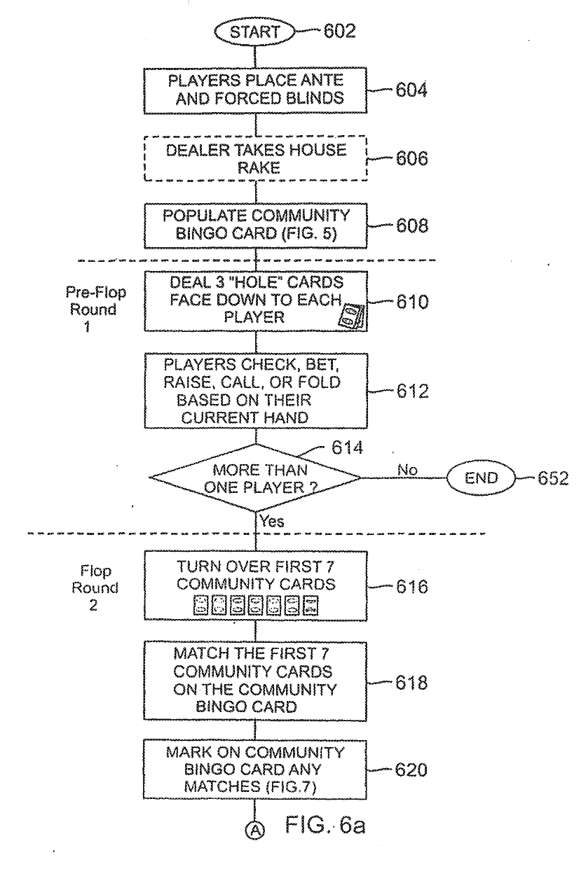

The game may also be played in a multiplayer format in which players compete against other players as shown in FIG. 5, which depicts a game 100 that includes a standard “Texas Hold'em” style poker table 102, deck of cards 104, and a 5×5 bingo matrix 106. Additionally, an automated card shuffler 108, dealer button 110, small blind button 112, big blind button 114, missed blind button 116, poker chips 118 for each player, house rake box 120, 2 to 10 players, discard pile 126, and optionally, a dealer can be included into game 100.

Bingo matrix card 106 can be printed onto paper and changed each game 100. Alternatively, and more preferably, bingo matrix card 106 can be fitted to a screen that electronically populates matrix 106 each time a new game is requested. A touch-screen can be provided so that spaces on card 106 can be populated and easily marked. Alternatively, an automated card reader 130 integrated into the plasma screen can scan and automatically mark bingo matrix 106 based on card 104 that is turned over in play.

While a 5×5 matrix 106 is in this embodiment game 100 is not limited to twenty-five spaces. As such, bingo matrix 106 can have fewer or more rows and columns. Furthermore, the number of rows do not necessarily have to match the number of columns and can be longer or wider such that card 106 does not form a square.

In some embodiments, the middle space of matrix 106 can be marked with “Free”. The free space indicates that players do not need to fill in the space to generate bingos. While the free space is generally placed in the middle of matrix 106, the space may be placed anywhere on card 106. Preferably, however, no free space is provided.

Game elements 12 may be considered for illustrative purposes as cards having “suits” that are distinguished by colors such as green, orange, purple or blue. Alternatively, cards 12 can be distinguished with suits such as spades, hearts, diamonds, and clubs. Still yet, cards 12 can be distinguished by color and spades, hearts, diamonds, or clubs. One skilled in the relevant art will appreciate that card 12 suits can be distinguished by shading or different patterns and is not limited to any one way or method. As will be shown, the suit determines whether a flush or non-flush bingo can be achieved through the community cards 122 and hole cards 124.

Matrix 106 can be marked with matching cards 12 either by a dealer or automatically. Game 100 can include an automated card reader to mark the matrix 106. The card reader can read both the suit and number indicated on any card 12 and automatically populate bingo matrix card 106. While it is preferable that 2 to 10 players can play game 100, it is not necessary. In a game having a deck of 100 cards 12, is envisioned that a maximum number of 26 players can play the game with each player having three hole cards 124 and a total of twenty-one community cards 122 dealt.

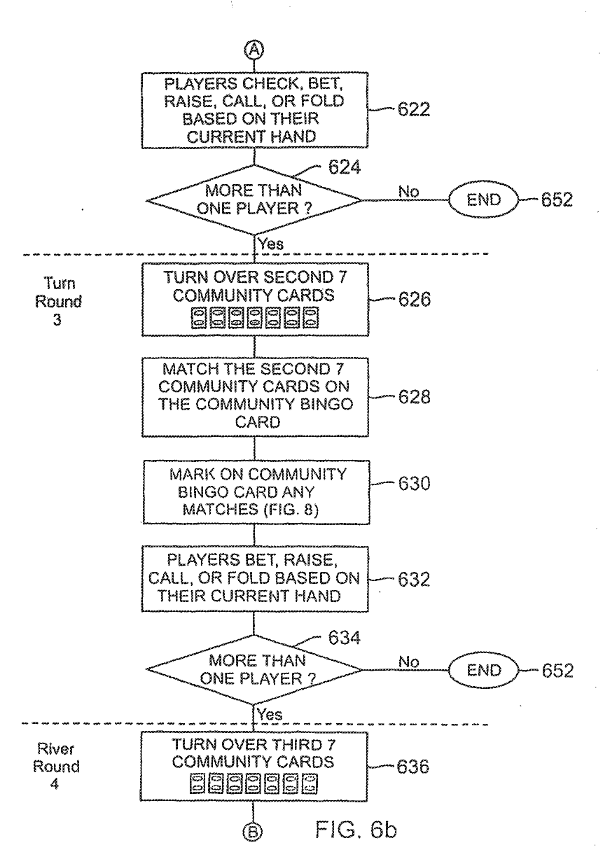

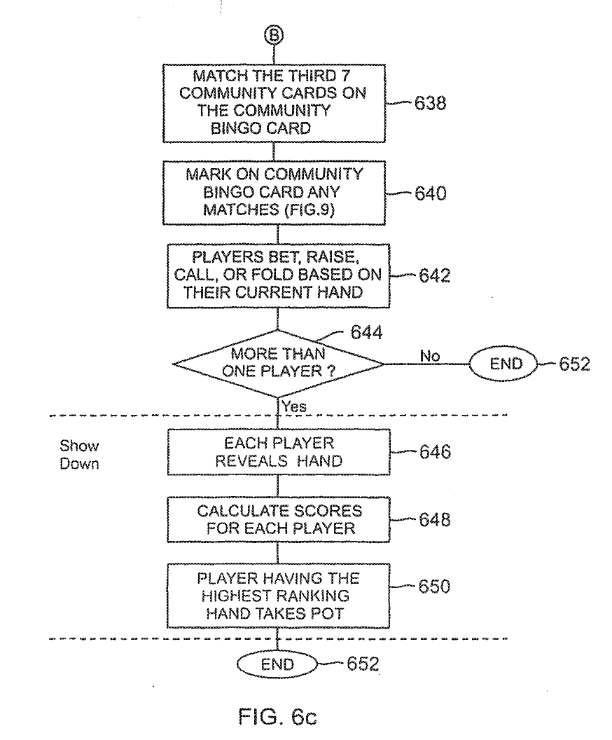

With reference now to FIG. 6a, a flow diagram illustrating exemplary processes performed in game 100 is presented. The process to play game 100 begins at block 602. At this point, game 100 has two or more players. In some embodiments, deck of cards 104 are shuffled by a human dealer or in automated card shuffler 108. Cards 104 may further be grouped into three groups of seven community cards 122.

At block 604, players place an ante and forced blinds similar to “Texas Hold'em” poker or an alternative method. For example and as provided above, one player can place a small blind into the pot, while another player places a big blind into the pot.

At optional block 606, a dealer can take a house rake from the pot. Similar to other casino table games, the house takes a rake in order to generate revenue for the casino. Typically, the dealer is generally not a player. In a home version where friends are playing together, no house rake is needed.

Continuing with FIG. 6, a community bingo card 106 is populated at block 608. Generally, game 100 includes four rounds. Each round is indicated by a dotted line as shown in FIG. 6. Round 1 begins at block 610. Round 1 is known as the pre-flop round. In this round, three hole cards 124 are given face down to each player. Hole cards 124 are taken from the deck of 100 cards 12. The hole cards 124 are concealed so that no other player may see the cards 124. If necessary, these cards 124 can be revealed at the showdown, a final stage of game 100. These cards 124 represent the unique hand that a player may have in trying to obtain a bingo based on bingo matrix card 106 that the other players cannot see.

While three hole cards 124 are typically given, in some embodiments, fewer or more hole cards 124 may be given. At block 612, a pre-flop bet is placed. As described above, players may check, bet, raise, call or fold based on their three hole cards 124. Strategically, a player having three hole cards 124 positioned within the populated bingo matrix card 106 that can obtain the maximum number of bingos will likely stay in game 100. On the other hand, if the player's hole cards 124 had a slight chance of forming a bingo, then the player would be less inclined to raise or bet and would rather check, call, or fold. At block 614, a determination is made whether more than one player is still in game 100. If only one player is left, that player is awarded the pot and game 100 ends at block 652.

Round 2 begins at block 616. After the pre-flop betting round and assuming that there are at least two players taking part in game 100, the dealer deals a flop. The flop consists of seven community cards 122 from deck 12. These cards 122 are dealt face up. At block 618, the seven community cards 122 in the flop are matched with spaces on the bingo matrix card 106 and the bingo matrix card 106 is marked corresponding to those matches at block 620. In the card 106 provided above, matches are shown in FIG. 7. As shown in FIG. 7, spaces on the grid including column B/row 1, column B/row 2, column I/row 1, column N/row 3, column N/row 4, column G/row 1, and column O/row 3 have been marked on bingo matrix card 106 corresponding to the first seven community cards 122 in the flop round.

Continuing with round 2, a flop betting round begins at block 622. Players can once again check, bet, raise, call or fold based on their three hole cards 124 and the seven community cards 122. At block 624, a determination is made whether more than one player is still in game 100. If only one player is left, that player is awarded the pot and game 100 ends at block 652.

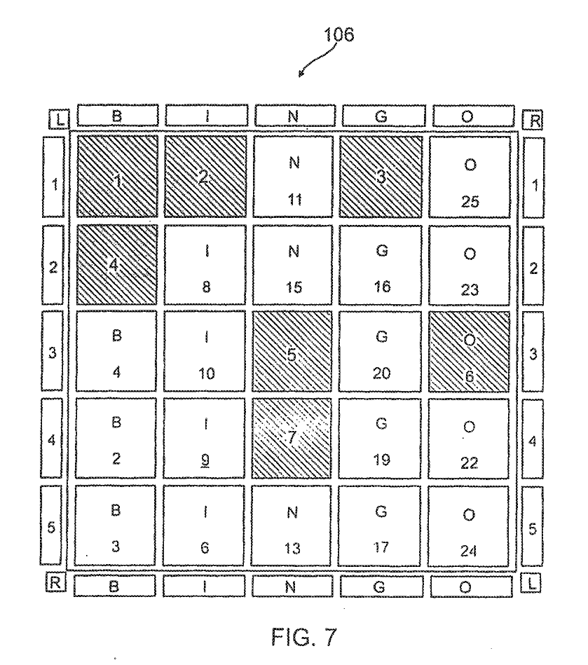

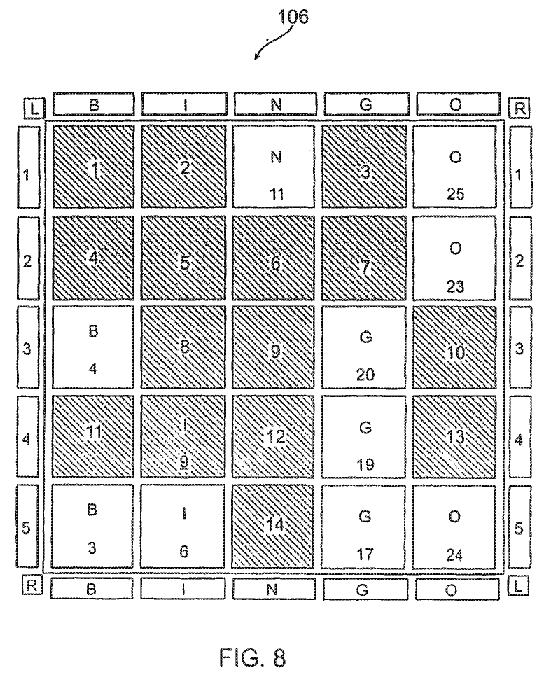

If at least two or more players remain, round 3 begins at block 626, also known as the turn round. The turn in game 100 consists of turning an additional seven community cards 122. These cards 122 are dealt face up. At block 628, the seven community cards 122 in the turn are matched with spaces on the bingo matrix card 106 and the bingo matrix card 106 is marked corresponding to those matches at block 630 as shown in the exemplary card 106 provided in FIG. 8. As shown in FIG. 8, spaces on matrix 106 including column B/row 4, column 1/row 2, column I/row 3, column N/row 2, column N/row 5, column G/row 2, and column O/row 4 have been marked on bingo matrix card 106 corresponding to the second seven community cards 122 in the turn round.

Continuing with round 3, a turn betting round begins at block 632. Players can check, bet, raise, call or fold based on their three hole cards 124, the first seven community cards 122 and the second seven community cards 122. At block 634, a determination is made whether more than one player is still in game 100. If only one player is left, that player is awarded the pot and game 100 ends at block 652.

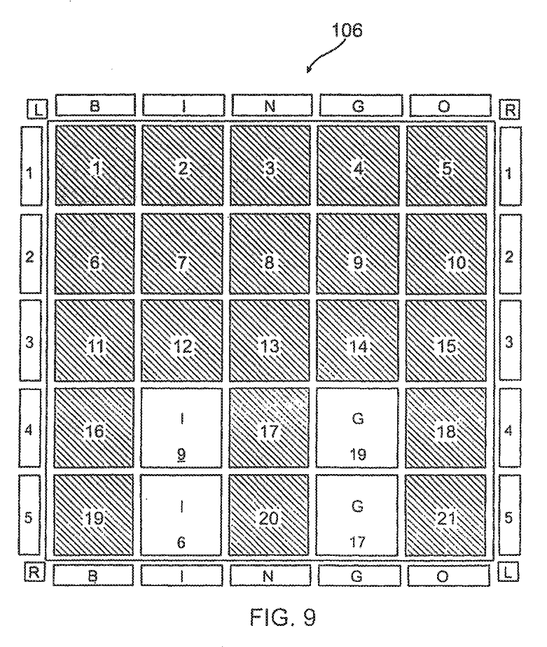

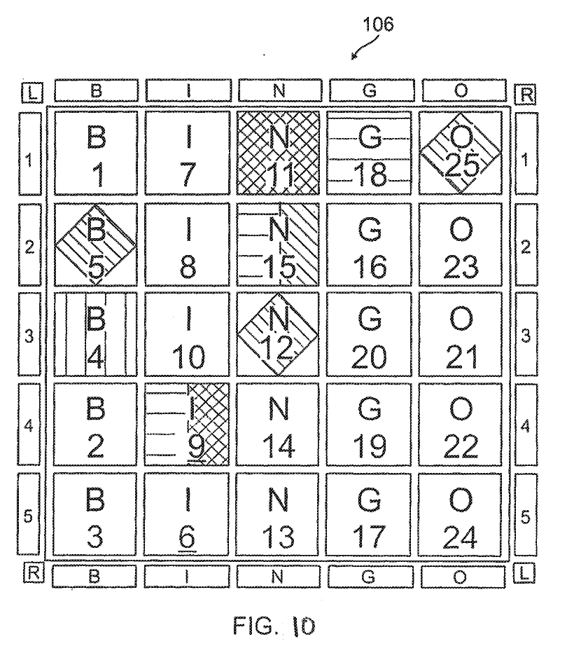

If two or more players remain, round 4 begins at block 636, known as the river round. The river consists of seven community cards 122. These cards 122 are dealt face up. At block 638, the seven community cards 122 in the river are matched with spaces on the bingo matrix card 106 and the bingo matrix card 106 is marked as such at block 640. As shown in FIG. 9, spaces on matrix 106 including column B3, column B/row 5, column N/row 1, column G/row 3, column O/row 1, column O/row 2, and column O/row 5 have been marked on bingo matrix card 106 corresponding to the third seven community cards 122 in the river round.

Continuing with round 4, a river betting round begins at block 642. Players can check, bet, raise, call or fold based on their three hole cards 124, flop seven community cards 122, turn seven community cards 122, and the river seven community cards 122. At block 644, a determination is made whether more than one player is still in game 100. If only one player is left, that player is awarded the pot and game 100 ends at block 652. The remaining player typically does now show their hole cards 124.

If two or more players remain after the final betting round, a showdown Occurs: In the showdown, each remaining player reveals their hole cards 124 at block 646. A score is generated based on the three hole cards 124 and the twenty-one community cards 122, which will be described below, at block 648. A total score is developed based on every bingo achieved by the player. Thereafter, the player having the highest score takes the pot at block 650 ending the process at block 652.

While several steps have been recited, not all of them necessarily need to occur in this order. Also, more or less rounds may be used, each round having varying amounts of community cards 122. In one embodiment, game 100 can include one or two rounds having eight or nine community cards 122. Alternatively, game 100 can include a single round having twenty-one community cards 122. One skilled in the relevant art will appreciate that game 100 may come in a variety of forms.

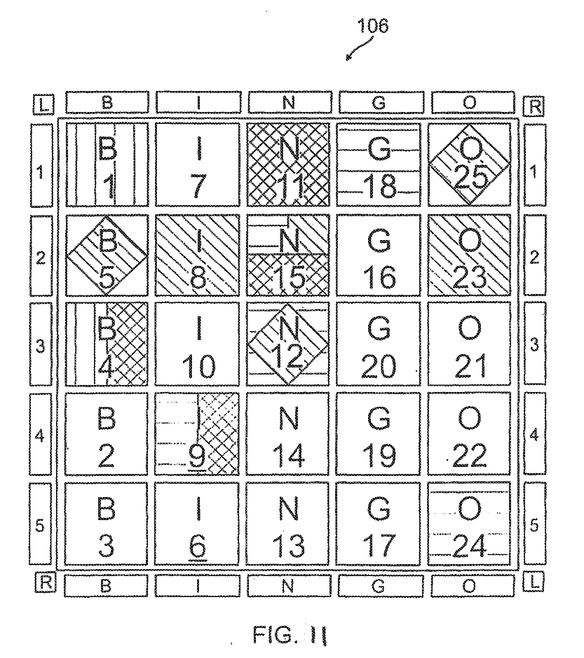

With reference now to FIGS. 11, 12, and 13, an illustration of how these types of duplicate, triplicate, and quadruplicate matches can be made are shown after each round of game 100. FIG. 11 depicts another embodiment of bingo matrix card 106 populated after the first round. As shown, spaces on grid 128 including column B/row 3, column I/row 4, column N/row 1, column N/row 2, and column G/row 1 have been marked on bingo matrix card 106 corresponding to the first seven community cards 122 in the flop round. Noticeably, spaces in column I/row 4 and column N/row 2 have been matched two times with different community cards 122 making it less likely for a player to obtain a bingo.

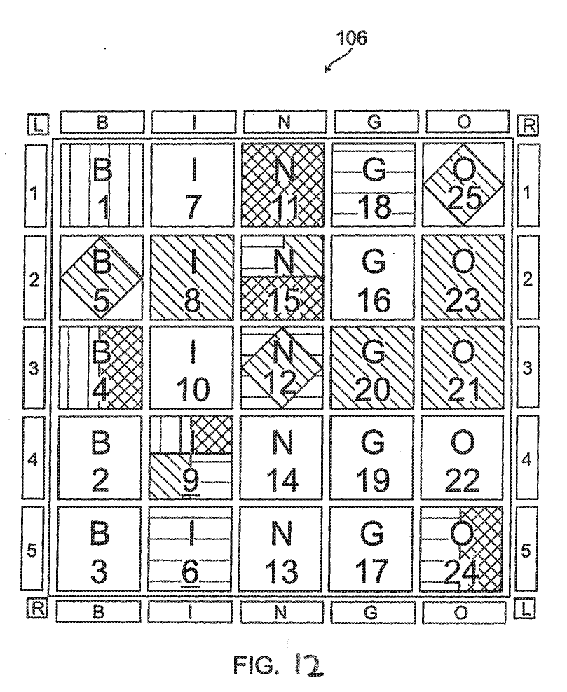

FIG. 12 depicts the previous bingo matrix card 106 after an additional seven community cards 122 are turned face up. Spaces on grid 128 including column B/row 1., column B/row 3, column I/row 2, column I/row 4, column N/row 1, column N/row 2, column G/row 1, column O/row 2, and column O/row 5 have been marked on bingo matrix card 106 corresponding to the additional seven community cards 122 in the turn round. Spaces in column B/row 3 and column I/row 4 have been matched two times with different community cards 122 and the space in column N/row 2 has been matched three times with different community cards 122.

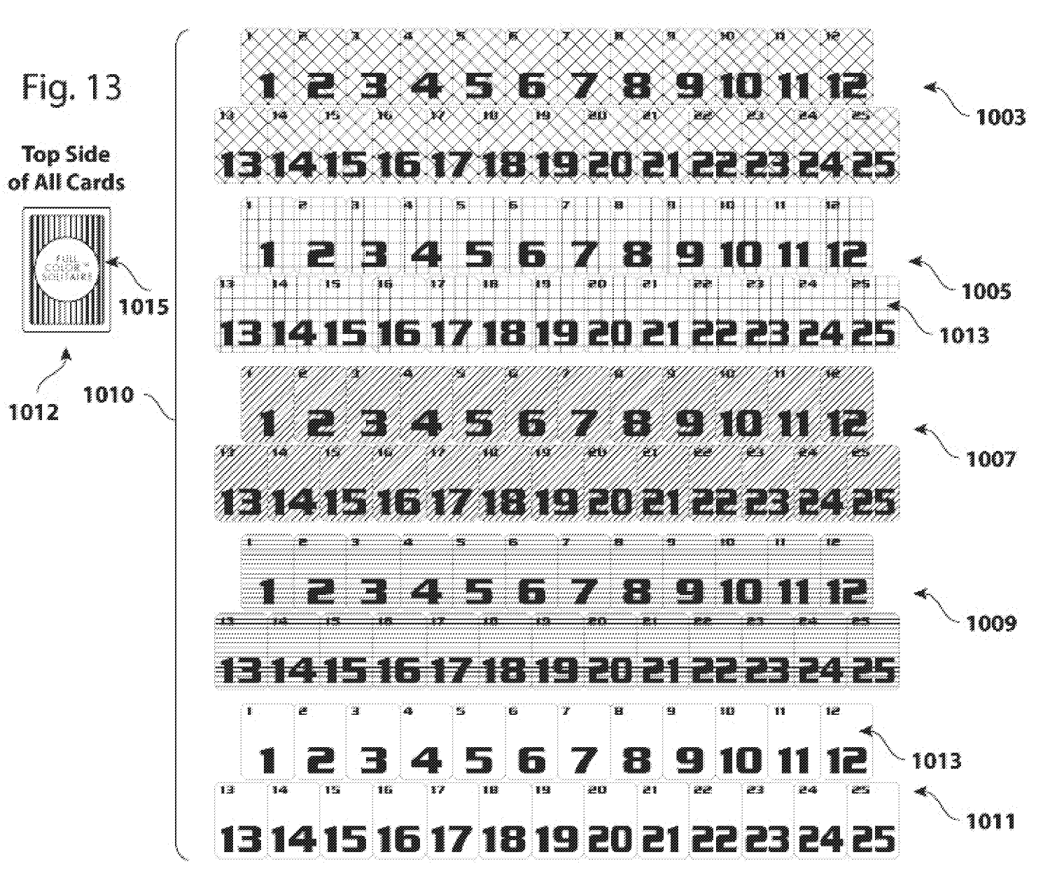

FIG. 13 depicts the previous bingo matrix card 106 populated after the third round. Spaces on the matrix 106 grid including column B/row 1, column B/row 3, column I/row 2, column I/row 4, column l/row 5, column N/row 1, column N/row 2, column N/row 3, column G/row 1, column G/row 2, column G/row 3, column O/row 2, column O/row 3, and column O/row 5 have been marked on bingo matrix card 106 corresponding to the additional seven community cards 122 in the river round. Spaces in column B/row 3 and column O/row 5 have been matched two times, the space in column N/row 2 has been matched three times, and the space in column I/row 4 has been matched four times with different community cards 122.

In another exemplary embodiment of the invention shown in FIG. 13, a game device 1010 includes game elements 1012 which generally resemble a physical deck of cards having a front face 1013 and rear face 1015, but may also be configured as virtual representations thereof. In this embodiment, game elements or deck 1012 includes one hundred and twenty five cards having features which may be generally categorized as colors and numbers. The colored gaming elements (e.g., green, orange, purple, blue and white or non-colored) are capable of being arranged into twenty-five card subsets identified by arrows 1003 (which for illustrative purposes may represent the color green), 1005 (which for illustrative purposes may represent the color orange), 1007 (which for illustrative purposes may represent the color purple), 1009 (which for illustrative purposes may represent the color blue) and 1011 (which for illustrative purposes may have no color or otherwise represent the color white), respectively. The colors are represented herein by various distinguishable patterns on front face 13 of cards 12, which is also included within the spirit and scope of the invention for situations in which patterned cards rather than colored cards may be preferred. Cards 1012 in subsets 1014 through 1022 include consecutive integers from 1 to 25.

It should be understood that game device 1010 is a non-limiting example of the many variations of a game device according to the invention. For example, deck 1012 may have a different number of game elements, such as fifty. Also, other colors and numbering schemes may be employed in the spirit and scope of this invention. Moreover, other indicia, such as letters or words may also be added to the game elements to form subsets. In addition to game devices such as those described herein, the invention is also directed to game play methods that may utilize game devices according to the invention.

Exemplary game methods involve the random dealing of game elements. In some of the embodiments herein, the game elements are dealt into preset arrangements. The preset arrangements may be formed by systemically placing randomized game elements into multiple piles of game elements, with one or more game elements being placed face down or face up. Some game elements may be used to form a reserve pile or stack. The final or top element in any pile is typically allowed to be manipulated or moved from its initial position to another position in a different pile, free position, waste pile, foundation position or tableaux, for example, in order to expose an element in the pile thereunder, which may further assist in achieving the ultimate goal of the game.

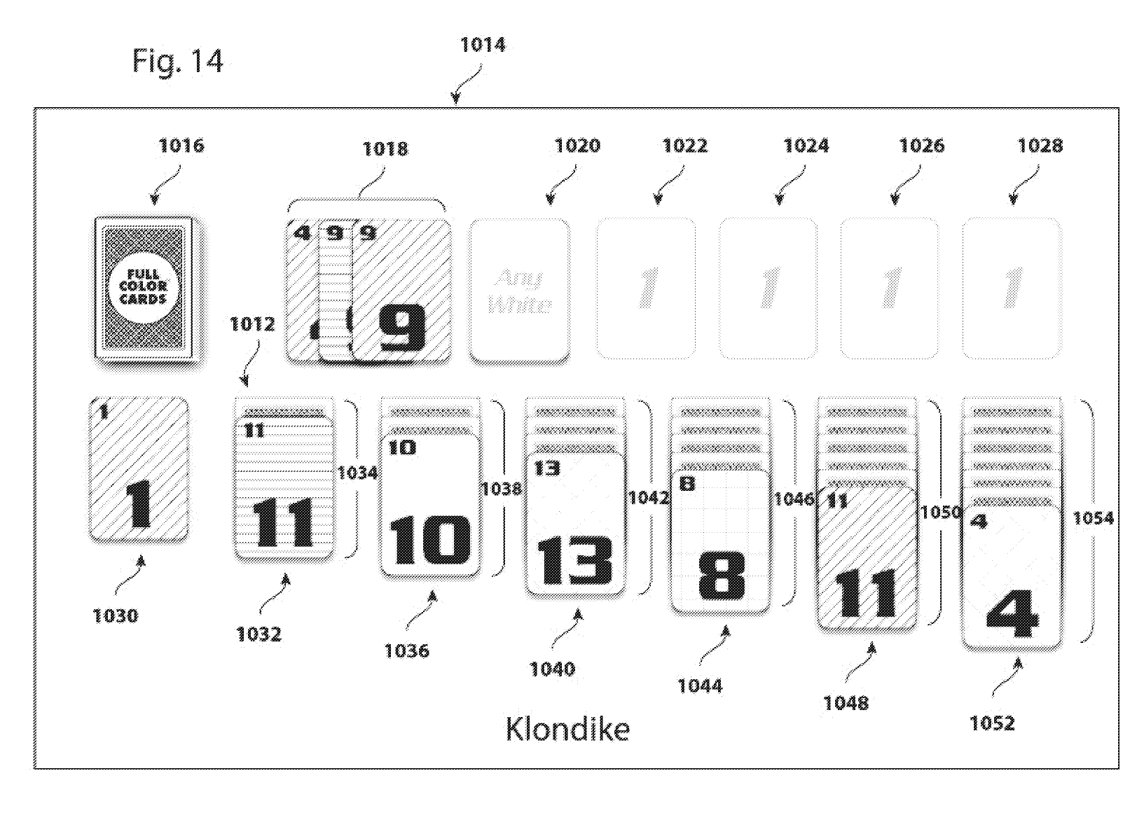

By way of an illustrative example, the preset arrangements may be similar to the arrangements of standard playing cards in one or more versions of the game of solitaire, such as Klondike, pyramid, spider or freecell, for example. FIGS. 14-20 illustrate exemplary embodiments in which game elements 1012 have been randomly dealt into various piles for purposes of providing a game system in accordance with the invention.

Upon dealing the game elements, resolution of the game or game play will involve the manipulation of one or more game elements according to a preset criteria or code from this initial condition of random game elements into a winning condition. For example, the preset criteria may set forth the relationship between the game elements which must be satisfied in order to change the condition of the game by repositioning game elements to ultimately place the game elements into the winning condition.

For example, the preset criteria may set forth that a first element from a first pile may be non-permanently moved by placing the first element on or over a second element in a second pile if the first element is of a different color or pattern than the second element and if the number on the first element is sequentially numbered one less than the second element upon which it is to be placed. In the above example, the first element would then be included with the second element in the second pile.

Alternative preset criteria which must be satisfied in order to move a first element includes the following examples: if the first element is of the same color or pattern and has a number which is one more than the second element, then the first element may be placed on or over the second element; if the first element is of a different color or pattern and has a number which is one more (or any number more or less) than the second element, then the first element may be placed on or over the second element; if the first element is of a different color or pattern and has a number which is either even (or odd) as compared with the second element, then the first element may be placed on or over the second element; and if the first element and the second element are adjacent and include numbers which may be combined together (or subtracted from each other) to achieve a particular value, then both the first element and second element may be moved to a third pile, which may consider color or pattern (the same or different color or pattern) or be irrespective thereof. It should be readily apparent that the above are non-limiting alternative examples, and many other variations and modifications may be included within the spirit and scope of the invention.

In some embodiments of the invention, one or more of the subsets of game elements may be manipulated according to second criteria that differs from the preset criteria. For example, in one embodiment, the non-colored, white or elements without pattern may be moved immediately upon being exposed to a separate foundation for such elements. In this embodiment, the white elements are randomized and dealt with the other elements and affect game play but are not subject to the same preset criteria. In other embodiments, the non-colored elements (or a colored element) may be “wild” in that it can substitute for any other element, or may have other functions which differ from the other subsets. In some embodiments, the one or more subsets subject to the second preset criteria are restricted to the second preset criteria and may not be manipulated according to the preset criteria. In some embodiments, one or more subsets of elements are subject to a third criteria which differs from both the preset criteria and the second criteria. In some embodiments, the one or more subsets which may be manipulated according to the second criteria may be a number, color or pattern or other indicia on the game elements. In some embodiments, the second criteria may be any of the alternative examples of preset criteria described herein.

Embodiments of the invention may be played as a competition against other players, either remotely or together, or against the clock, that is, to attempt to place game elements in the winning condition in the shortest time possible or within a preset time limit. In some embodiments, a wager or entry fee is received by one or more players prior to beginning the game according to the invention. It should be understood that steps recited herein may be carried out in a variety of ways, such as by physically using game elements, via an electronic gaming machine (EGM) in a gaming establishment, through a home gaming system, computer or portable device, such as a mobile phone, capable of communicating via the Internet, global telecommunication network or world wide web.

In some embodiments, players are provided with an interface through which they may select from a plurality of game variations which utilize various versions of a game device according to the invention. Game elements 1012 are dealt according to a preset layout that depends on the selected game and may then be individually manipulated according to preset criteria. The total amount of time spent in resolving the game may be recorded for comparative or competition purposes.

Embodiments of the invention are directed to a game device referred to hereinafter as the Full Color™ Cards or Full Color™ Solitaire which includes game elements such as those shown in the attached documents. Although the elements are referred to as “cards,” it should be understood that the system may be played in a computerized setting with virtual representations of the elements or cards.

The cards have identical small and large numerical markings which facilitates identifying the card rank when stacking cards on top of each other. One embodiment of a deck of Full Color™ Cards includes a total of 125 cards, divided in 5 sets of green, orange, purple, blue and white colors, wherein each set includes cards numbered sequentially 1 through 25.

In the descriptions that follow, like parts are marked throughout the specification and drawings with the same numerals, respectively. The drawing figures are not necessarily drawn to scale and certain figures may be shown in exaggerated or generalized form in the interest of clarity and conciseness. Although cards are referred to by color, the colors of the cards are depicted as patterns in the figures. Each pattern is unique to one color, as shown by arrows 1003, 1005, 1007, 1009 and 1011 in FIG. 13.

FIG. 14 is an exemplary illustration that depicts a game embodiment 1014 of a deck Full. Color™ Cards shown in FIG. 13 with five unique colored suits for a total of one hundred and twenty five Full Color™ Cards 1012. The deck may have more or less than 13 sequentially ranked cards in a suit and should not be considered limiting. In FIG. 14, cards 1012 have been randomly dealt out in order to provide for play of a game 1014 which is similar in configuration to the solitaire game known as Klondike. In this embodiment, game 1014 is configured to include a stock pile 1016, a waste pile 1018, a white suit foundational pile 1020, a green suit foundational pile 1022, an orange suit foundational pile 1024, a purple suit foundational pile 1026, a blue foundational suit 1028, a first tableau 1030 with one card dealt face up, a second tableau 1032 with one card dealt up 1034 and one card dealt face down, a third tableau 1036 with one card dealt up and two cards dealt face down 1038, a fourth tableau 1040 with one card dealt up and three cards dealt face down 1042, a fifth tableau 1044 with one card dealt up and four cards dealt face down 1046, a sixth tableau 1048 with one card dealt up and five cards dealt face down 1050, a seventh tableau 1052 with one card dealt up and six cards dealt face down 1054 in accordance with the Klondike-like game aspect of this embodiment.

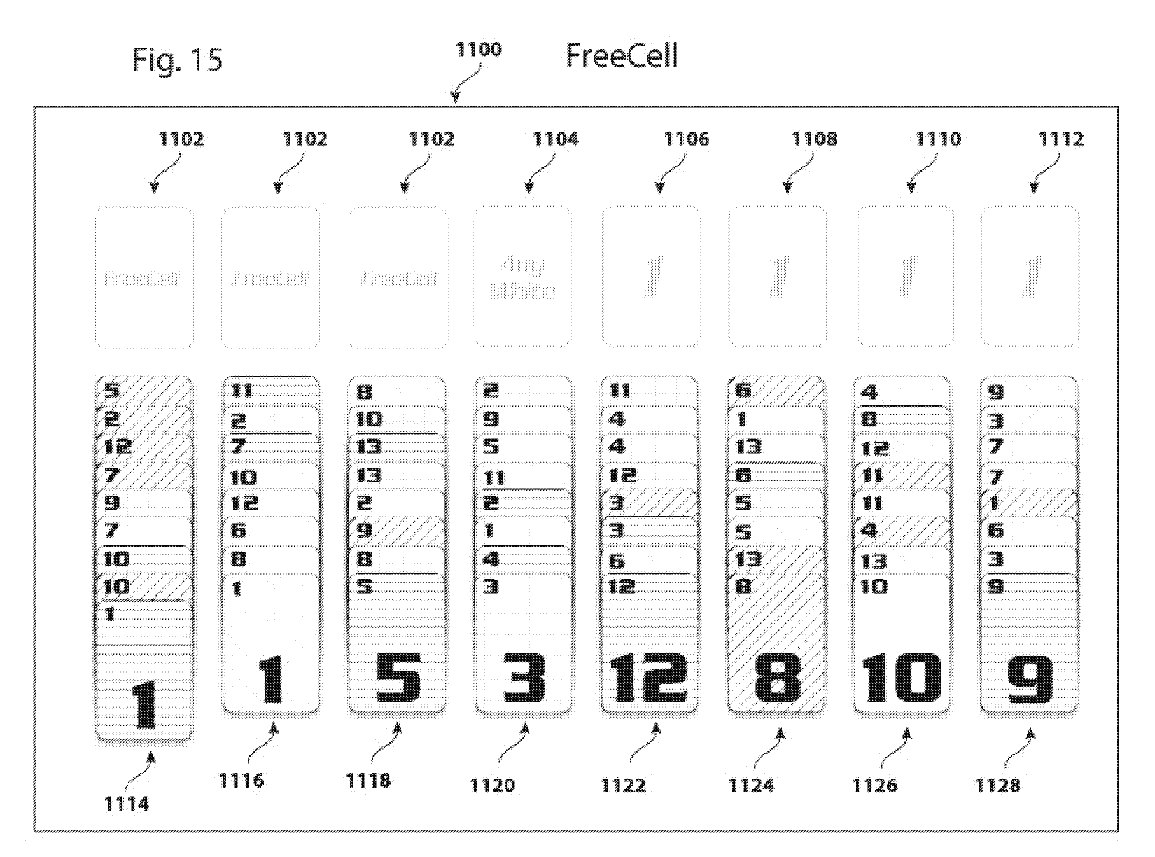

FIG. 15 is an exemplary illustration that depicts an embodiment showing a randomly dealt out game 1100 according to the invention which is meant to appear similar in configuration to Solitaire FreeCell but utilizes cards 1012. As shown, game 1100 includes three freecell slots 1102; a white suit foundational pile 1104; a green suit foundational pile 1106; an orange suit foundational pile 1108; a purple suit foundational pile 1110; a blue foundational suit 1112; and eight tableaus 1114, 1116, 1118, 1120, 1122, 1124, 1126 and 1128.

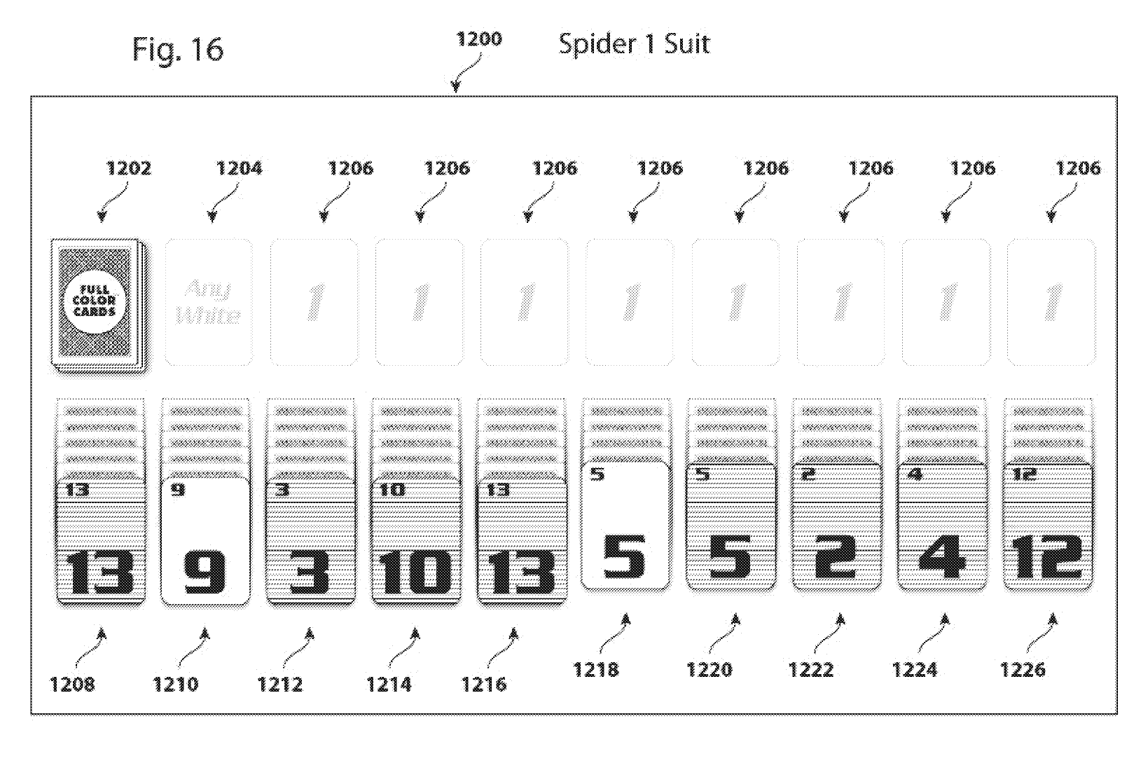

FIG. 16 is an exemplary illustration that depicts one embodiment showing a randomly dealt out game 1200 which is a variation in similar configuration as the solitaire game known as Spider, utilizing one set of white cards and four copies of blue cards from the game elements 1012. As shown, in this embodiment there is a white suit foundational pile 1204; eight blue suit foundation piles 1206; and ten tableaus 1208, 1210, 1212, 1214, 1216, 1218, 1220, 1222, 1224 and 1226. Initially the current embodiment 55 cards are dealt out face down into the 10 tableaus except for the top card of each one having a card face up. The tableau piles build down by rank, and in-suit sequences can be moved together. The 75 remaining cards are dealt to the tableau ten at a time when none of the top cards or piles can be moved any further. Once an in-suit sequence reaches its entire rank of all sequenced cards (in the current embodiment a total of 13 cards) all cards are then moved into the foundation pile freeing up the tableau for other cards to move to it or the top card above the 13 furthering the game play. The player will move all 8 in-suit sequences of 13 to each of the 8 foundational piles to win the game. The degree of difficulty in this game can be increased by adding more cards to the suit rank sequence, be it 16, 19, 22, 25 and more as well as turning on or off the capacity to undo the card moves. The number of tableaus, cards dealt out to them and cards in the leftover stockpile increase proportionally to the total number of cards in the initial deal.

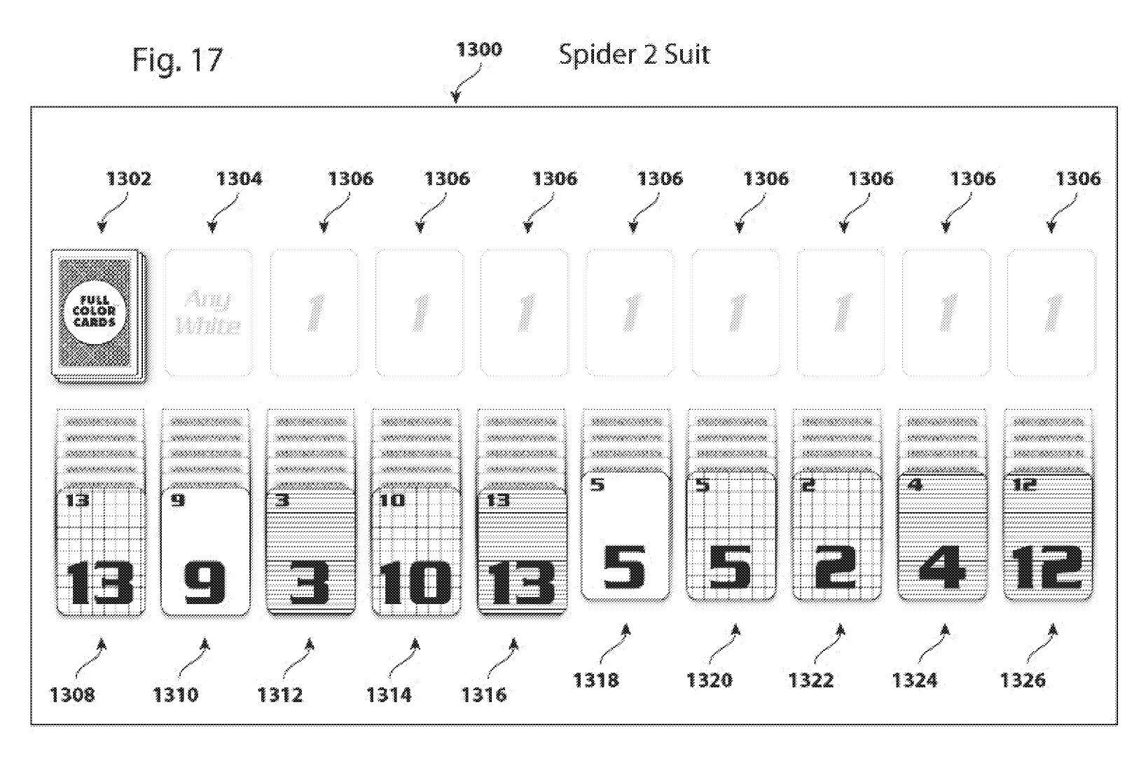

FIG. 17 is an exemplary illustration that depicts an embodiment showing a randomly dealt out game 1300 which is configured similarly to the game known as Solitaire Spider, in which there are 2 suits or sets of cards 1012. In particular, there is a total of five suits of thirteen sequentially ranked cards 1012 utilizing one through thirteen in which one suit is white and there are two copies of the one suit of blue and two copies of a second suit of orange for a total of 65 cards and then 2 copies or a double deck of the cards for a total of 130. As shown, there is one stock pile 1302; a white suit foundational pile 1304; 4 blue suit foundation piles 1306; 4 orange suit foundation piles 1308; an ten tableaus 1310, 1312, 1314, 1316, 1318, 1320, 1322, 1324, 1326 and 1328. Initially the current embodiment 55 cards are dealt out face down into the 10 tableaus except for the top card of each one having a card face up. The tableau piles build down by rank, and in-suit sequences can be moved together. The 75 remaining cards are dealt to the tableau ten at a time when none of the top cards or piles can be moved any further. Once an in-suit sequence reaches its entire rank of all cards (in the current embodiment a total of 13 cards) all cards are then moved into the foundation pile freeing up the tableau for other cards to move to it or the top card above the 13 furthering the game play. The player will move all 8 in-suit sequences of 13 to each of the 8 foundational piles to win the game. The degree of difficulty in this game can be increased by adding more cards to the suit rank sequence, be it 16, 19, 22, 25 and more as well as turning on or off the capacity to undo the card moves. The number of tableaus, cards dealt out to them and cards in the leftover stock pile increase proportionally to the total number of cards in the initial deal.

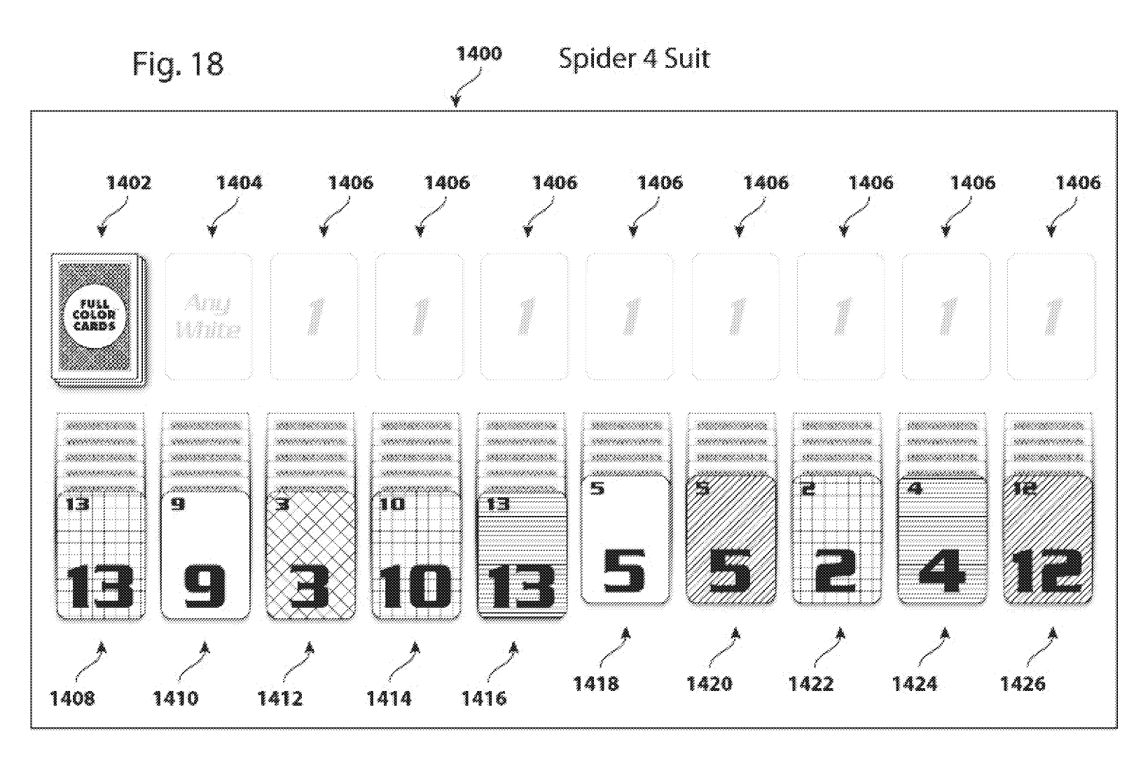

FIG. 18 is an exemplary illustration that depicts one embodiment showing a randomly dealt out game 1400 of Solitaire Spider with four subsets of cards 1012. In particular, there is a total five suits of thirteen sequentially ranked cards of game elements 1012 utilizing one through thirteen in which one suit is white and there are one suit of green, one suit of orange, one suit of purple and one suit of blue for a total of 65 cards and then 2 copies or a double deck of the cards for a total of 130 cards in the game. As shown, there is one stock pile 1402; a white suit foundational pile 1404; 2 green suit foundation piles 1406; 2 orange suit foundation piles 1408; 2 purple suit foundation piles 1410; 2 blue suit foundation piles 1412, an ten tableaus 1414, 1416, 1418, 1420, 1422, 1424, 1426, 1428, 1430 and 1432. Initially the current embodiment 55 cards are dealt out face down into the 10 tableaus except for the top card of each one having a card face up. The tableau piles build down by rank, and in-suit sequences can be moved together. The 75 remaining cards are dealt to the tableau ten at a time when none of the top cards or piles can be moved any further. Once an in-suit sequence reaches its entire rank of all cards (in the current embodiment a total of 13 cards) all cards are then moved into the foundation pile freeing up the tableau for other cards to move to it or the top card above the 13 furthering the game play. The players will move all 8 in-suit sequences of 13 to each of the 8 foundational piles to win the game. The degree of difficulty in this game can be increased by adding more cards to the suit rank sequence, be it 16, 19, 22, 25 and more as well as turning on or off the capacity to undo the card moves. The number of tableaus, cards dealt out to them and cards in the leftover stock pile increase proportionally to the total number of cards in the initial deal.

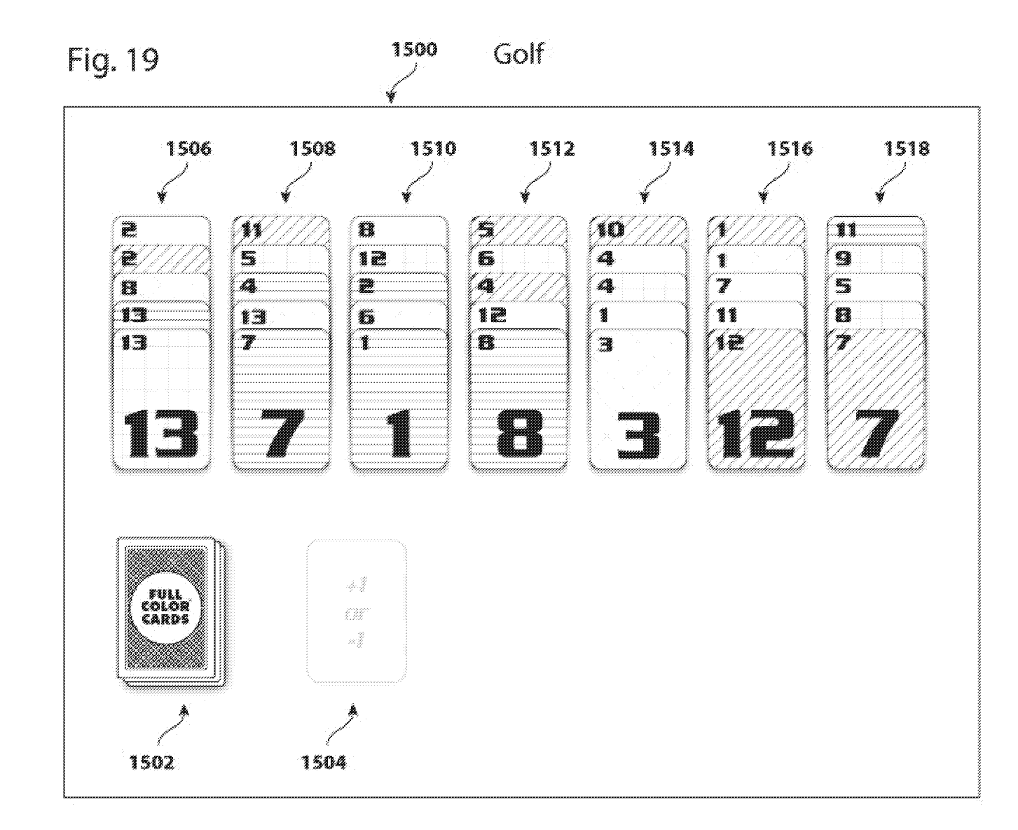

FIG. 19 is an exemplary illustration that depicts one embodiment showing a randomly dealt out game 1500 which is configured similarly to the game known as Solitaire Golf. In this embodiment, there is a total of five suits of thirteen sequentially ranked cards of one through thirteen in which one suit is white and there are one suit of green, one suit of orange, one suit of purple and one suit of blue for a total of 65 cards, all from game elements 1012. As shown, there is one stock pile 1502; a foundational pile 1504; seven tableaus 1506, 1508, 1510, 1512, 1514, 1516 and 1518. In the current embodiment, 35 cards are dealt out into the 7 tableaus all face up. The goal of the game is to place all the cards in the 7 tableau into the foundation by resorting the colored suited cards in a +1 or −1 sequential ranking order regardless of their suit however, all cards with a white suit are unrestricted and when they reach the top card position in the tableau or are dealt into the foundation from the stockpile 1502, they are automatically discarded from play. The current embodiment shows how the player begins the game with an empty foundation 1504 and the player can choose which card they want to start it with. Initially a card must be placed into the foundation from either the stockpile 1502 or the top of one of the tableau columns. The player will strategically choose a card to start a domino effect of connecting cards in sequential order higher or lower to the top most foundation card. Once a card is in the foundation 1504, cards may be moved from the tableau into the foundation if their face value is one more or one less than that of the card on top of the foundation. A 1 card is the lowest in Golf and only a 2 may be played on it when it is on top of the foundation. In the current embodiment, 13 is highest card and no card may be played on top of the highest card in the sequence in the foundation. If you place the highest card into the foundation, you must draw a card from the stock. If you can't make any more moves from the tableau, you may also draw a card from the stock. Once the stock is empty and no more moves are possible, the game is over. In other embodiments of the game the 1 or the 13 can be built upon by restarting at the top or bottom of the sequence with a 1 on top of a 13 or a 12 on a 13 or a 13 on a 1.

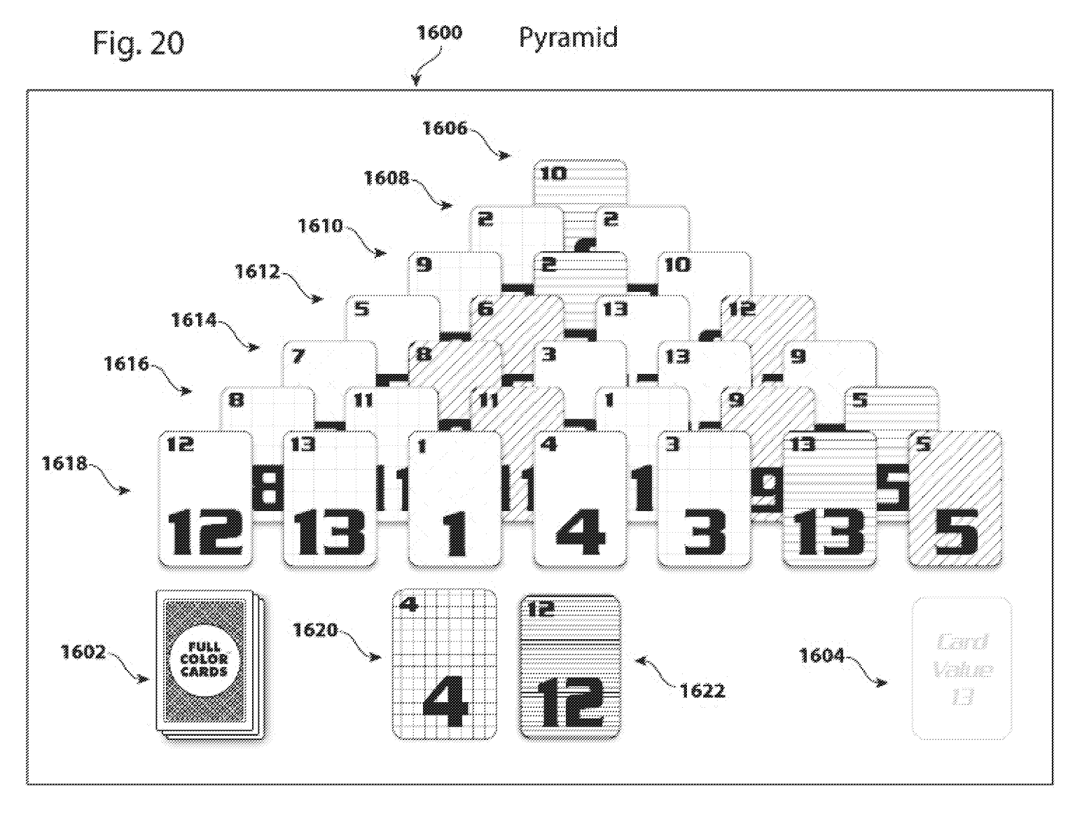

FIG. 20 is an exemplary illustration that depicts one embodiment showing a randomly dealt out game 1600 which is configured similarly the game known as Solitaire Pyramid. In this embodiment, there is a total five suits of thirteen sequentially ranked cards of one through thirteen in which one suit is white and there are one suit of green, one suit of orange, one suit of purple and one suit of blue for a total of 65 cards, all from game elements 1012. As shown, there is one stock pile 1602; a foundational pile 1604; seven tableaus 1606, 1608, 1610, 1612, 1614, 1616 and 1618 and a waste pile that has a first card draw 1620 that moves to a second waste card 1622 if it isn't used in play. In the current embodiment the pyramid is built with 1 card in the 1^{st} tableau, 2 in the 2^{nd}, 3 in the 3^{rd}, 4 the 4^{th}, 5 in the 5^{th}, 6 in the 6^{th} and 7 in the 7^{th} for a total of 35 cards dealt face up leaving 30 remaining in the stock pile 1602. In the current embodiment, the goal of the game is to place all the cards in the pyramid into the foundation. White cards have no restrictions and once they are on the top of a tableau or a waste pile they can be immediately discarded advancing the game play and freeing up more cards. Cards may be placed into The foundation in pairs by summing their card values to 13. A card is considered “in play” if it was just dealt as a face up card from the stock, it is the top card in the waste or it is a pyramid cards that is completely uncovered. A card can not be played if the card is covered by another card that it could be paired with, it is still not in play (since it is covered) and the cards may not be paired. The 13 card does not need to be paired with any other card and can be immediately moved to the foundation once it is in play. When a card in the first waste pile 1620 can't be played it moves to the second waste pile 1622. If the next card in the stock is comes up and is played into 1620, it can be paired with the card in 1622. Any top card in play from the pyramid can be paired with any card from 1620 or 1622 at any time to for the purposes of uncovering buried cards in order to advance the game play. The game ends when a player complete makes one complete pass through the stock 1602.

Although the games described herein are single player or individual games by design, electronic technology permits head to head competitions to occur whereby multiple players compete to see who can simultaneously solve identical games with an identical deal faster than their any other on linked electronic gaming platforms for a real or virtual prize, award or leader board recognition based on ending the game with the fastest time or best end score ranking.

In one illustrative embodiment, the game utilizes the game elements, system and methods disclosed herein which starts by dealing cards from a shuffled “deck” into a prescribed arrangement on a tabletop from which the player attempts to reorder the “deck” by “suit” and “rank” through a series of moves transferring cards from one place to another under prescribed methodical restrictions. Some games allow for the reshuffling of the deck(s), and/or the placement of cards into new or “empty” locations like “freecells” or “foundation” piles which also have restrictions or conditions upon them. Some games allow for a new and revolutionary new card gaming paradigm known as the “jumper card” method or the “bumper card” method depending on the method or skill level of game play that is chosen.

In one illustrative embodiment, game play begins with a physical (or electronic) tabletop configured for providing the game elements and game play method described herein. In the first round of play, the player may select games and a variety of options. For example, a selectable factor in the degree of difficulty is whether the player wants to allow moves to be tainted by allowing any number of moves to be undone.

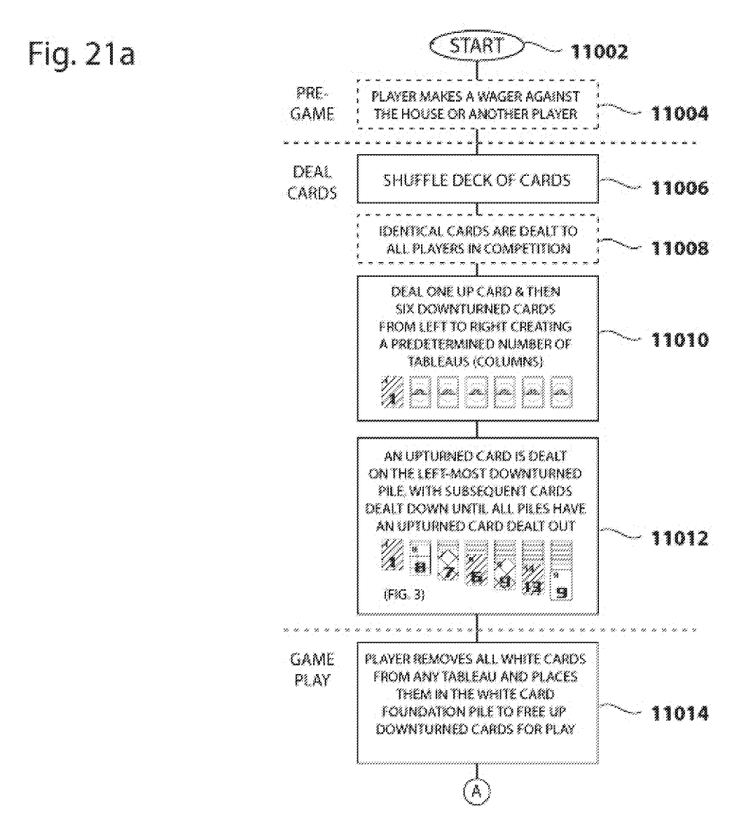

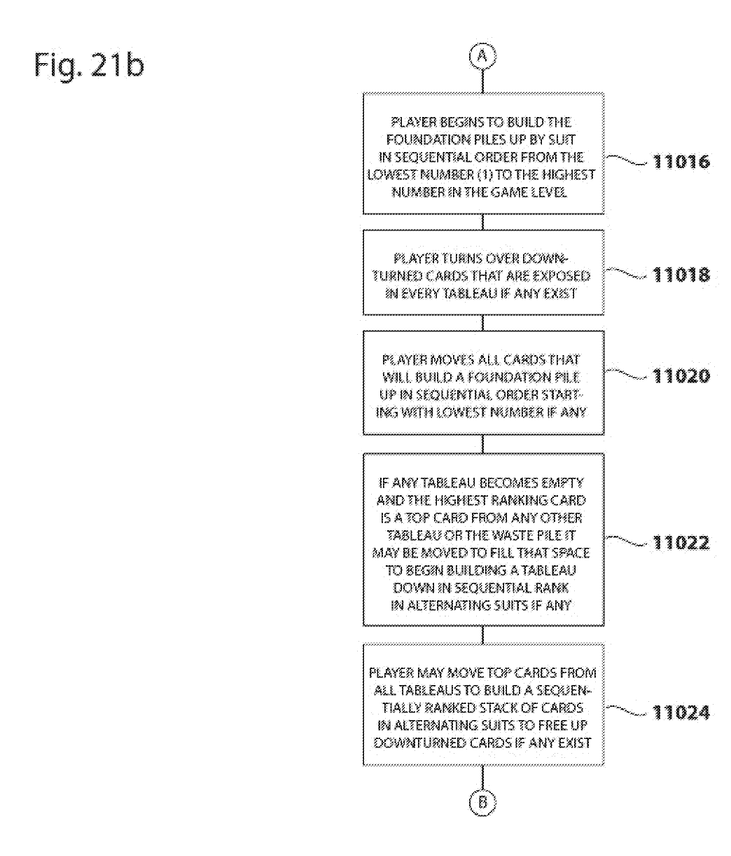

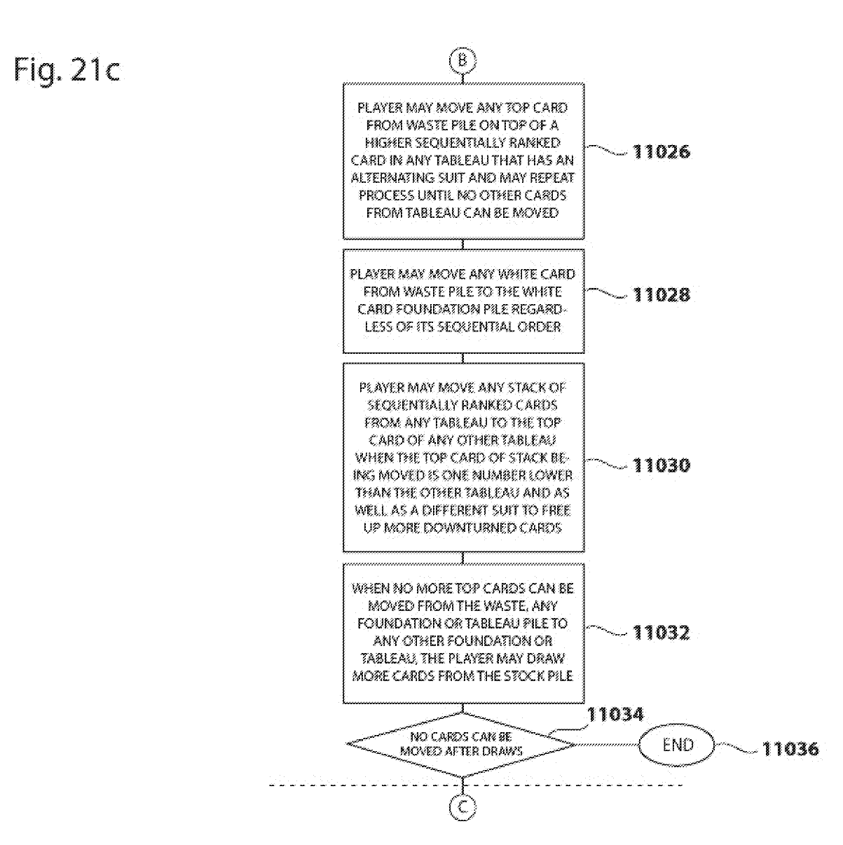

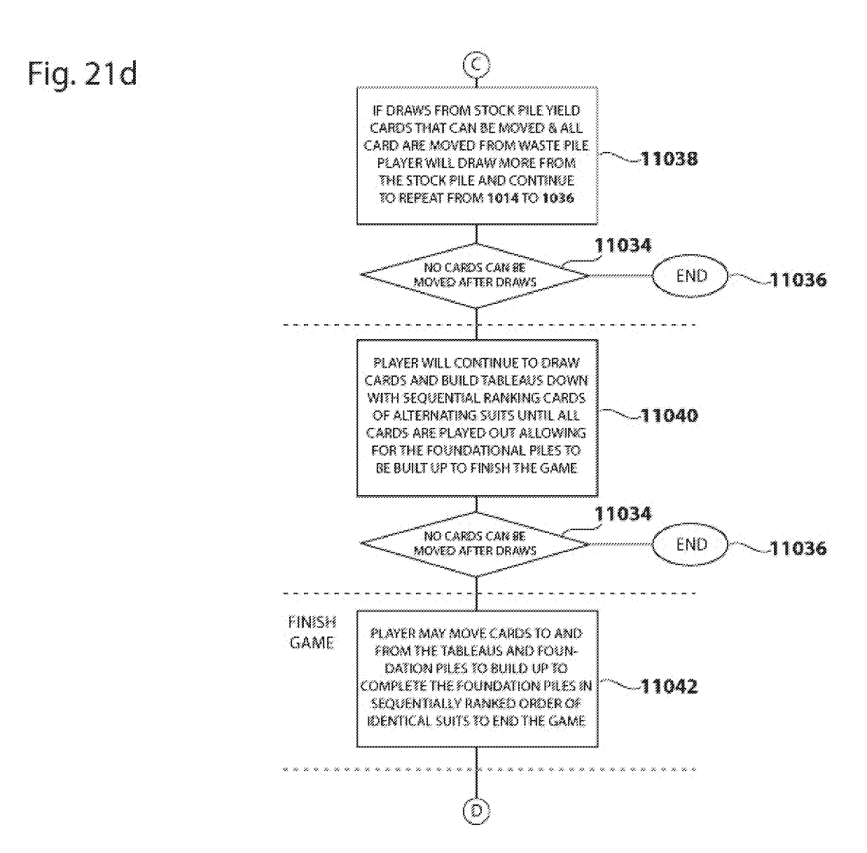

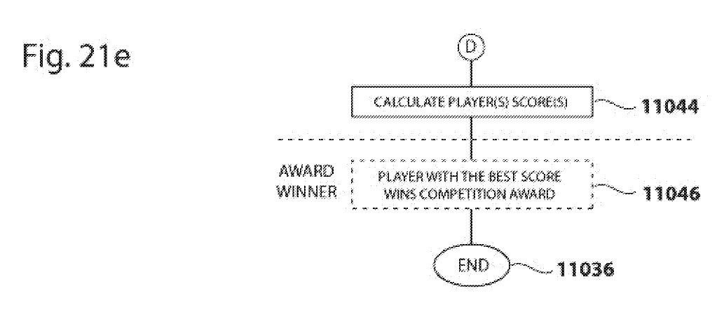

FIG. 21A-21E show a flowchart of the order of exemplary game play in block sequences according to some embodiments of the invention. The game play begins in block 11002. If a player is engaged in a competition or a wager, block 11004 depicts how a player will make a wager against the house or another player in heads up play. The game begins after the deck of cards 1012 have been randomly shuffled in block 11006. If a competition is play against other players in a remote electronic format, a computer system will deal identical cards to all players as seen in block 11008.

In some embodiments, cards are dealt out in accordance with block 1010 with one card up in the 1st tableau 30 of in FIGS. 14, and 6 more are dealt one at a time downturned in tableaus 2 through 7 in 1032, 1036, 1040, 1044, 1048 and 1052 respectively as illustrated in FIG. 14.

The game play continues whereby block 11012 depicts how an upturned card is dealt on the left most down turned pile of 1032, with subsequent cards dealt down until all piles 1030, 1032, 1036, 1040, 1044, 1048 and 1052.

FIG. 14 depicts how all remaining cards from the card system 10 are placed face down into the stock pile 1016.

If the game play continues to block 11042 the play may move cards to and from the tableau 1030, 1032, 1036 and 1040 and foundation piles 1022, 1024, 1026 and 1028 to build up to the complete foundation piles in sequentially ranked order of identical suits to finish the game.,

Once the game is completed the player's score is calculated in block 11044. In this embodiment, the sore is based on two factors. The first factor is an award of points based on how cards are moved. The scoring is simple. Waste to tableau card movement is a +10 for each card. Tableau to a foundation is a +10 points. The turnover of a downturned tableau card is a +5 points. Moving a card from the foundation to a tableau is a −15. It should be noted that a player obtains 10 points when cards are moved directly from the waste stack to a foundation. However, if the card is first moved to a tableau, and then to a foundation, then an extra 5 points are received for a total of 15. Thus in order to receive a maximum score, no cards should be moved directly from the waste to foundation.

The second factor in the award of points is based on timed game play option. Every game starts out with the ability to win 10,000,000 bonus points. A player loses the opportunity to collect a bonus point with every second of time that it takes to complete the game. The bonus points are calculated with the formula of 10,000,000 divided by the total time in seconds to finish the game. If playing the hardest level takes 60 minutes to play the game the maximum bonus points that could be awarded would be 60 minutes×60 seconds or 10,000,000/3600=2,777.78 bonus points in addition to the movement score.

If the game is a competition the game continues to block 11046 where a real or virtual prize or award is paid out or in the case of a non-wagering competition, the player's score is posted to a leader board and the game ends at block 11036.

Some embodiments utilize real money and some use virtual money, some use prizes, some use awards, some are competitions against the player themselves, some are against others remotely, some are just for fun. All employ a unique 2 part card system that is unique and proprietary that employs a unique suit that has restricted or unrestricted conditions that change the order of the deal, game development or game play that create new methods of playing Solitaire that are not possible with a traditional deck of 52 standard playing cards or any other deck in the world because no such deck has ever been invented or exists in the known commercial marketplace.

Other embodiments includes where one subset, such as the white cards, whereby once any card from this subset reaches a top card position anywhere in the game it can be instantly moved (or not moved into) to start its own foundation (regardless of its rank) thusly freeing up the stock, waste, cell or tableau card below it for other cards to move to, from or build on its vacated position to continue game development. Thus, the white cards can be removed from the flipped stock pile or the tableaus into its own foundation without having to be in any specific order.

Alternatively, once any card from this one subset reaches a top card position anywhere in the game it can be instantly moved (or not moved into) to continue building a foundation regardless of its own rank or the rank of the card in its own foundation thusly freeing up the stock, waste, cell or tableau card below it for other cards to move to, from or build on its vacated position to continue game development. Thus, the white cards can be removed from the flipped stock pile or the tableaus into its own foundation without having to be in any specific order.

Alternatively, once any card from this one subset reaches a top card position anywhere in the game it can be instantly moved to any other tableau and create the equivalent of an free cell in a tableau to move any other cards from any other suits onto thusly freeing up the stock, waste, cell or tableau card below it for other cards to move to, from or build on its vacated position to continue game development. Thus, the white card becomes a solo jumper card prior to being moved into its foundation pile.

Alternatively, a card from the subset that is located anywhere in a tableau can move to the top card of any other tableau taking with it the entire group of cards regardless of the other suits or numerical order they are in to facilitate game development. Thus, the white card becomes a jumper card that takes its “children” with it prior to being moved into its foundation pile.

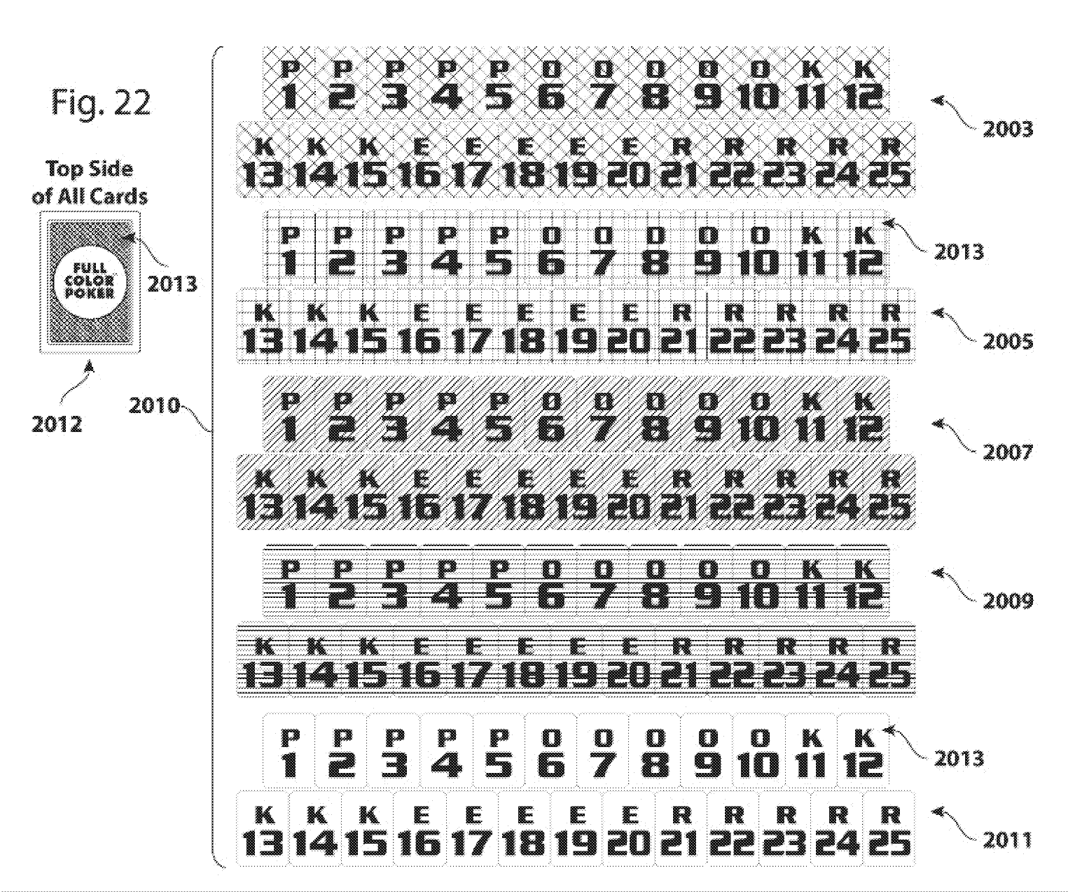

FIG. 22 illustrates another embodiment of the invention in which game device 2010 includes game elements 2012, wherein game elements include subsets of differing color or pattern on each face 2013, as shown by arrows 2003, 2005, 2007, 2009, and 2011, and include a subset of numbers from 1 to 25, and the letters POKER. In this embodiments, the letters POKER are disposed on game elements 2012 across subsets 2003, 2005, 2007, 2009, and 2011 as follows: the letter P is disposed on game elements 2012 which are numbered 1-5; the letter O is disposed on game elements 2012 numbered 6-10; the letter K is disposed on game elements 2012 numbered 11-15; the letter E is disposed on game elements 2012 numbered 16-20; and the letter R is disposed on game elements 2012 numbered 21-25.

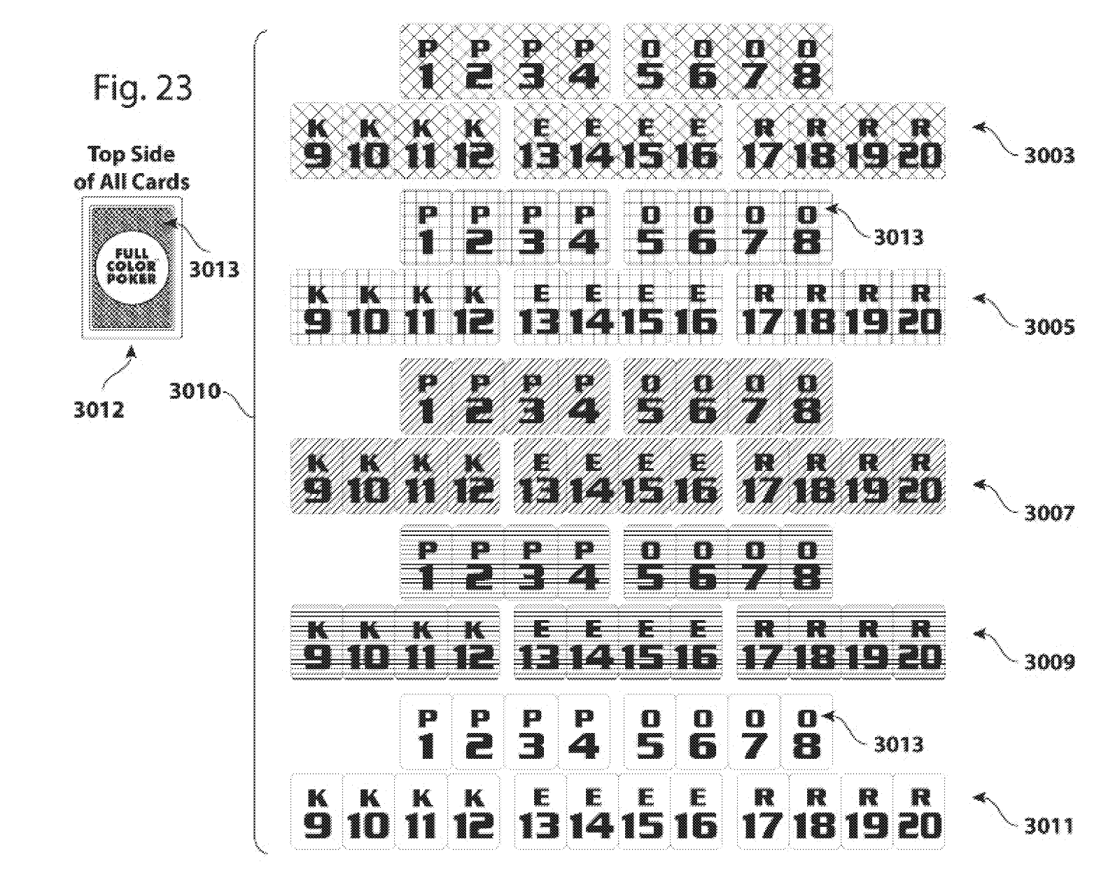

FIG. 23 illustrates another embodiment of the invention in which game device 3010 includes game elements 3012, wherein game elements include subsets of differing color or pattern on each face 2013, as shown by arrows 3003, 3005, 3007, 2009, and 3011, and include a subset of numbers from 1 to 20, and the letters POKER. In this embodiments, the letters POKER are disposed on game elements 3012 across subsets 3003, 3005, 3007, 3009, and 3011 as follows: the letter P is disposed on game elements 3012 which are numbered 1-4; the letter O is disposed on game elements 3012 numbered 5-8; the letter K is disposed on game elements 3012 numbered 9-12; the letter E is disposed on game elements 3012 numbered 13-16; and the letter R is disposed on game elements 3012 numbered 17-20.

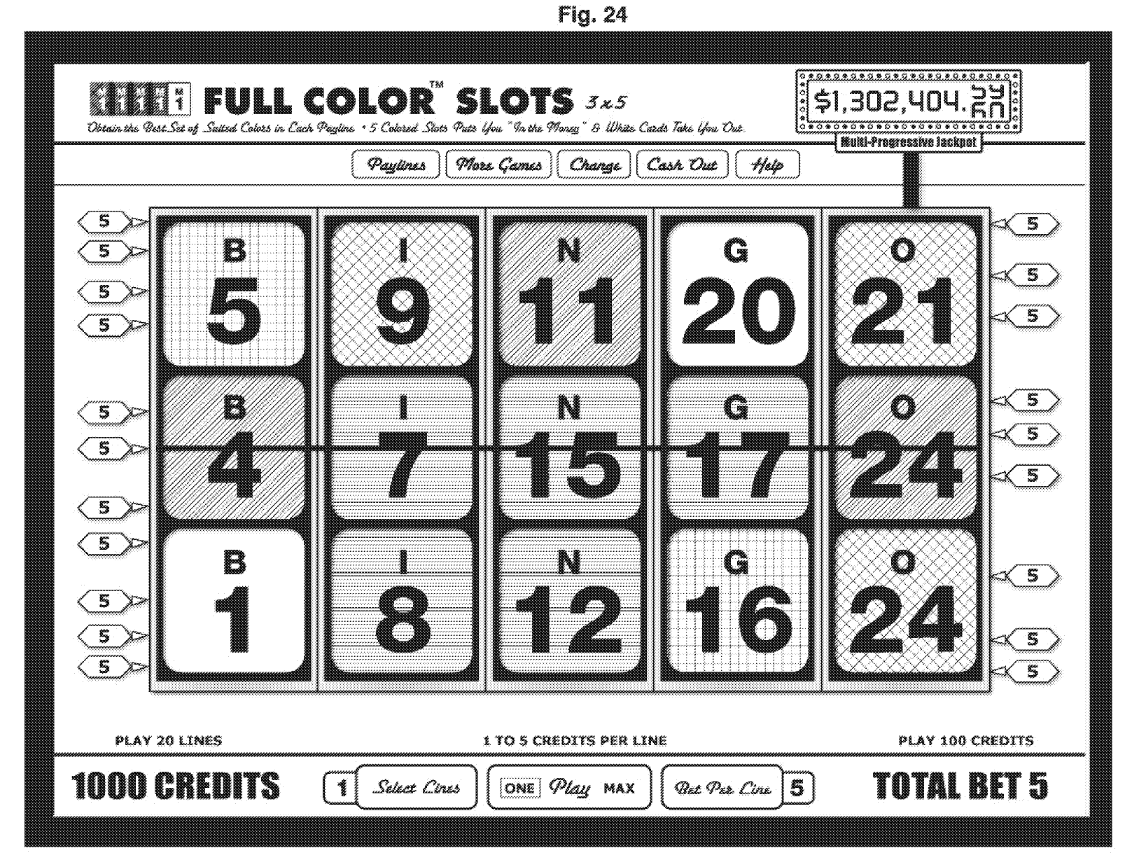

FIG. 24 illustrates game elements according to the invention utilized in an electronic gaming machine or slot machine. As shown, a winning line includes the game elements having three of the same pattern and two of the same pattern on the same horizontal line. It should be readily apparent that the slot machine may be configured to have a plurality of winning lines or configurations as known to those skilled in the art.

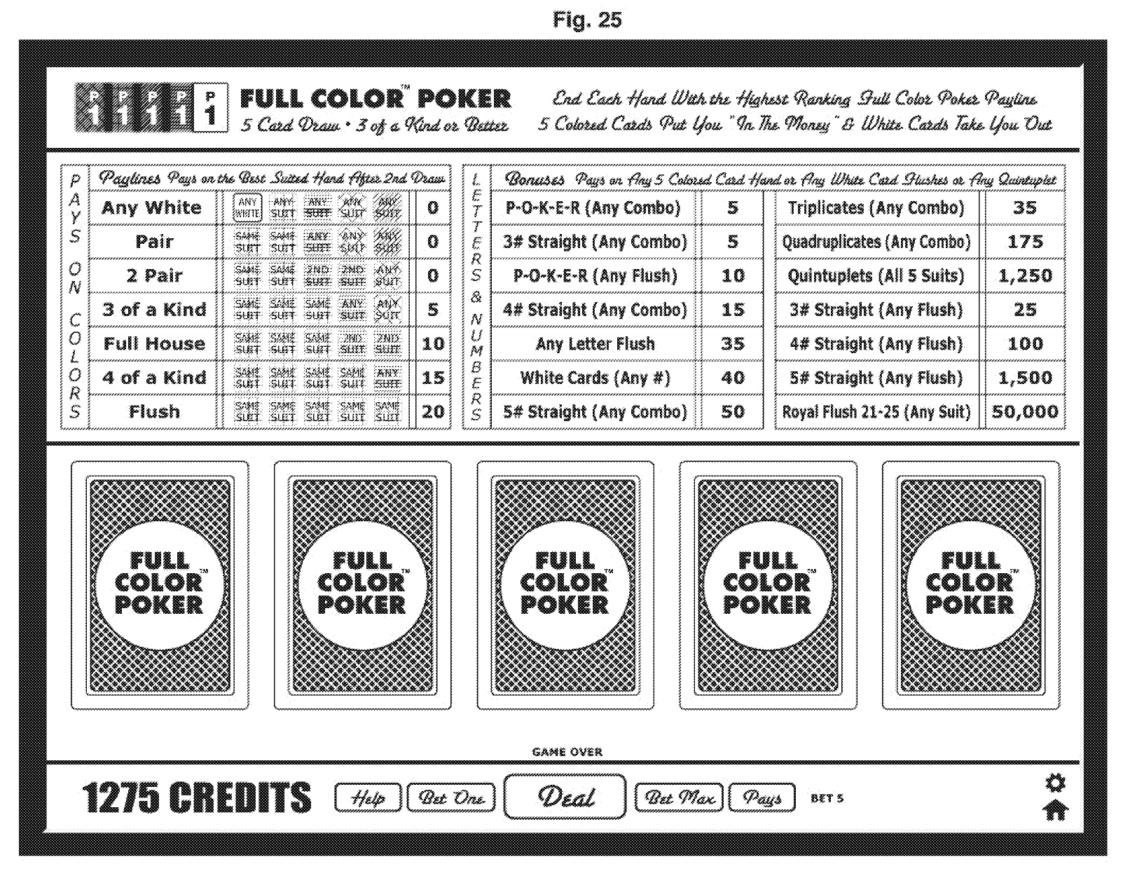

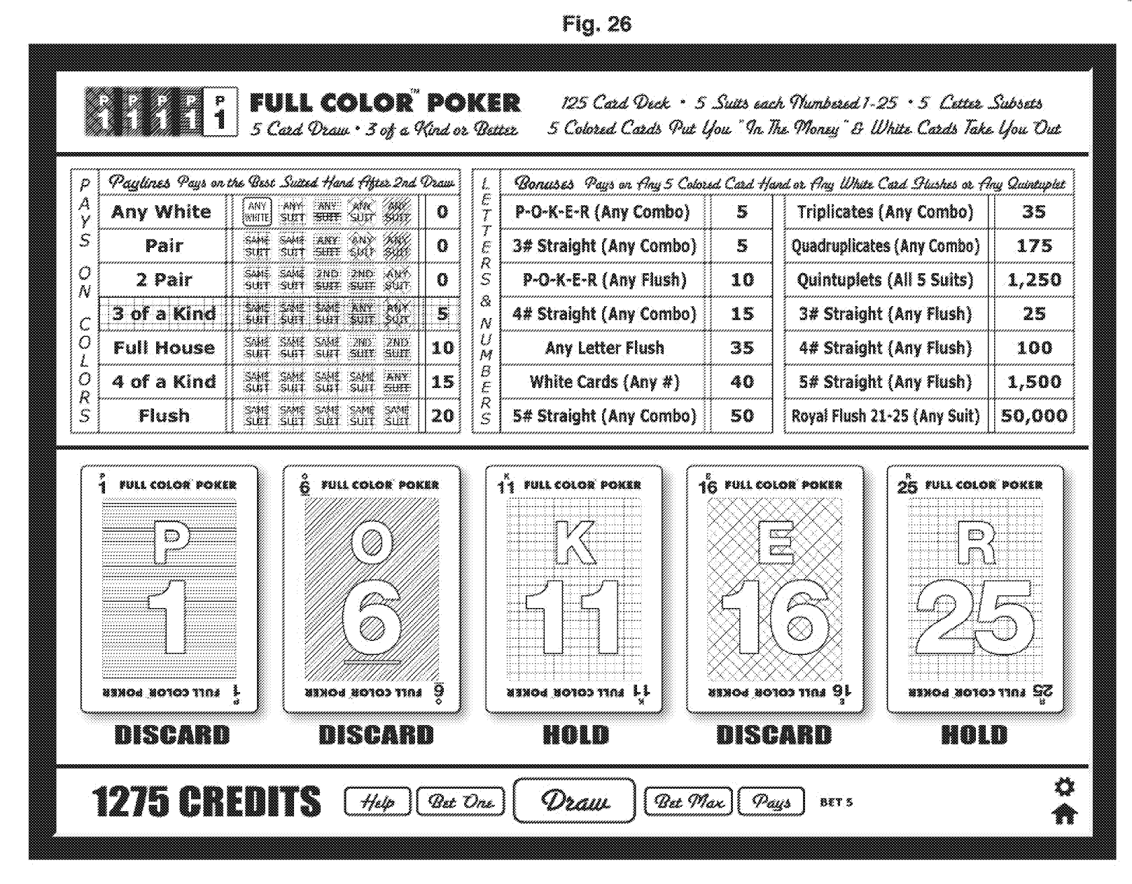

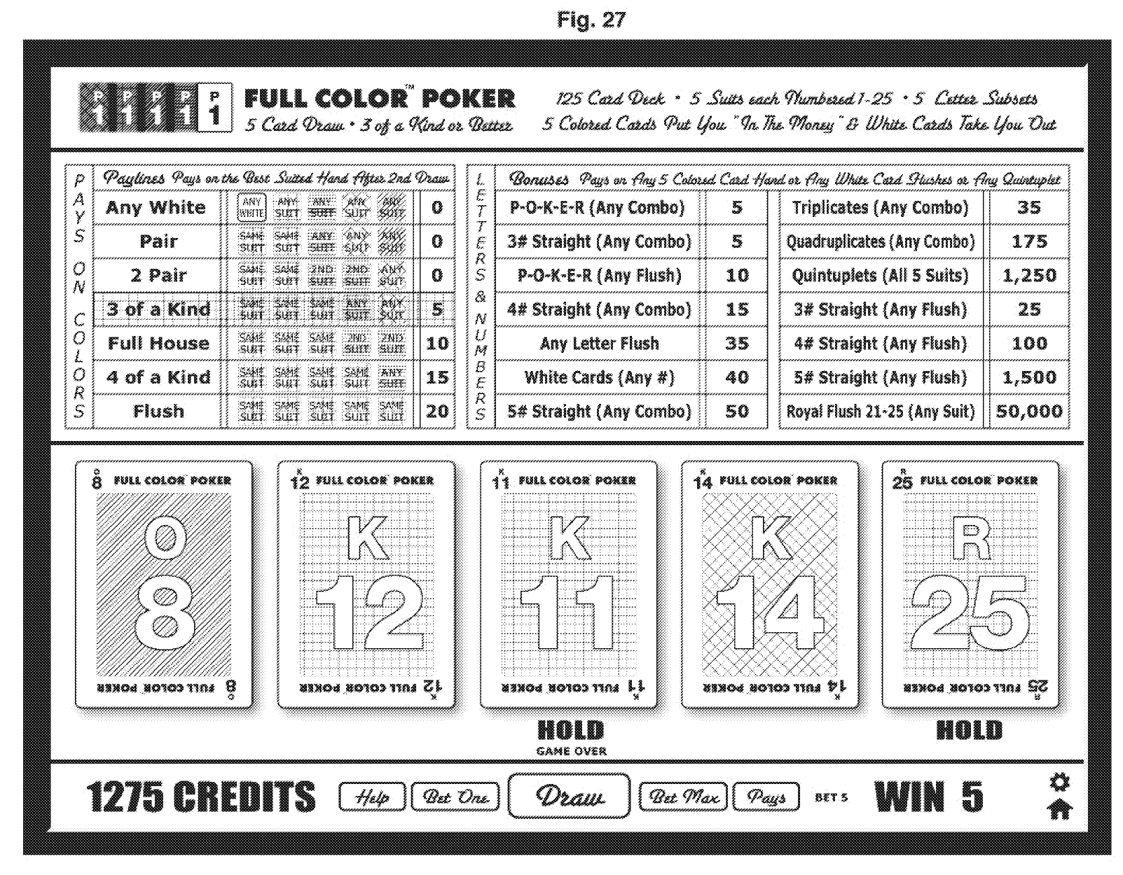

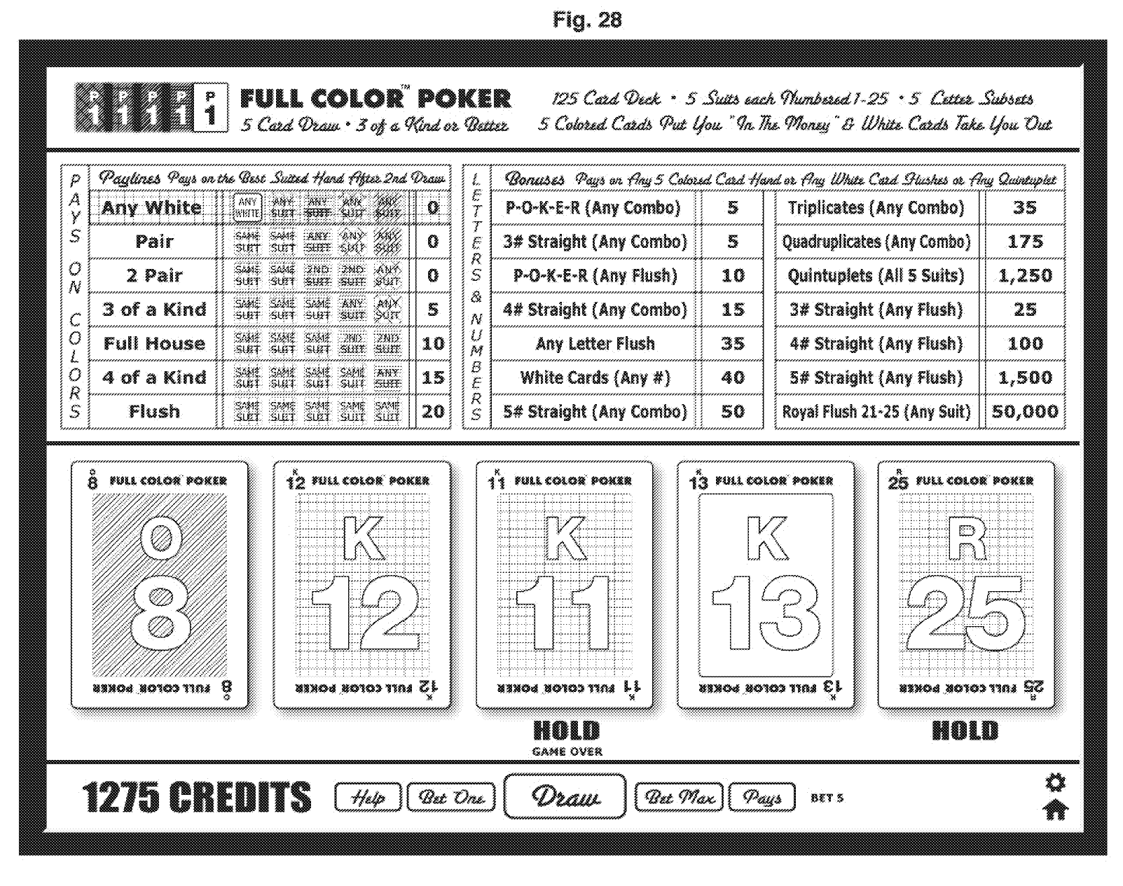

FIGS. 25 through 29 illustrate the play of a game according to the invention in which the game elements, such as in game device 2010 shown in FIG. 22, are used in the play of a game similar to five card draw poker. FIG. 25 illustrates an exemplary game screen that lists the rules and paytable of winning combinations and unit payout amounts based on the initial ante wager. Once the player places bet, which as shown herein is a bet of 5 units, the player may press or otherwise actuate the “deal” button. FIG. 26 illustrates the initial random deal of the cards from a deck such as deck 2010. The player may then select to hold or discard cards in the initial hand. In this embodiment the players has selected to hold the third and fifth card which have a matching pattern. The player would then press the deal or draw button and the discarded cards would be replaced with randomly dealt cards. As shown in FIG. 27 the player has a “3 of a kind” in that there are three cards in the hand from the “K” subset and thus wins 5 units on their wager. FIG. 28 illustrates an alternative outcome in which the player receives a white or non-patterned card as a result of the draw and thus according to one embodiment loses the game and their initial wager.

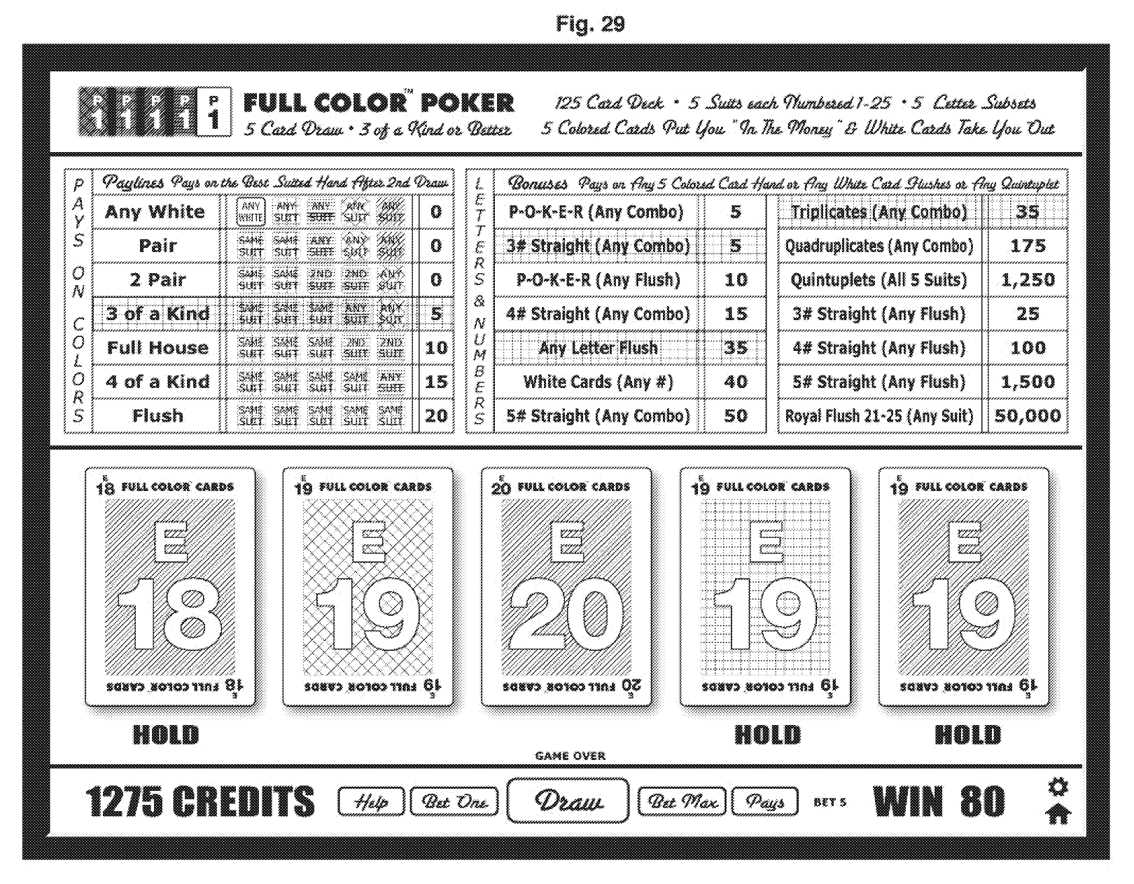

FIG. 29 illustrates another round of the game of this embodiment in which the final outcome includes multiple winning outcomes, that is, the final hand satisfied more than one winning criteria for each subset. As shown, the final outcome satisfies the “any letter flush” winning criteria because all cards are from the letter “E” subset, satisfies the “three of a kind” winning criteria because three of the five cards are in the same patterned or colored subset, satisfies the “3# straight” winning criteria because three of the five cards are numbered 18, 19 and 20, and satisfies the “triplicates” winning criteria because three of the five cards are numbered “19” respectively.

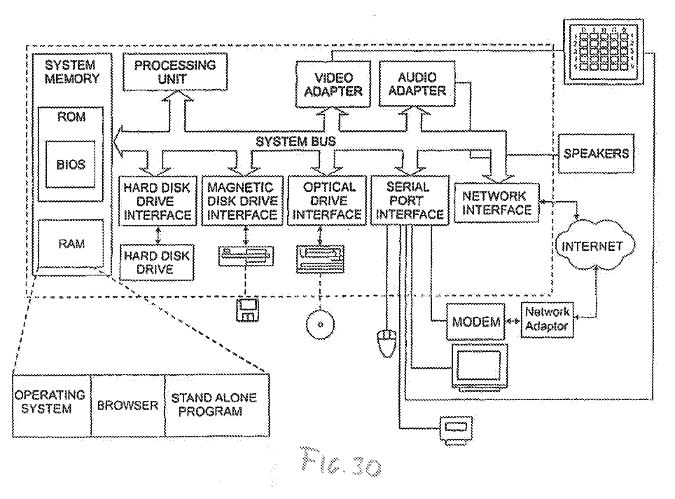

An exemplary hardware and operating environment for implementing gaming methods as described herein can include a general purpose computer system as shown in FIG. 30. Furthermore the hardware/software described below can be used for other electronic versions of game 100. The computer system may include a processing unit, system memory, and system bus that operatively couples various system components, including the system memory to the processing unit. There may be only one or there may be more than one processing unit, such that the processor of the computer comprises a single central processing unit (CPU), or a plurality of processing units, commonly referred to as a parallel processing environment. The computer may be a conventional computer, a distributed computer, a web server, a file server, or any other type of computer.

The system bus may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) and random access memory (RAM). A basic input/output system (BIOS), containing the basic routines that help to transfer information between elements within the computer, such as during start-up, is stored in ROM. The computer further includes a hard disk drive for reading from and writing to a hard disk, not shown, a magnetic disk drive for reading from or writing to a removable magnetic disk, and an optical disk drive for reading from or writing to a removable optical disk such as a CD ROM or other optical media.

The hard disk drive, magnetic disk drive, and optical disk drive are connected to the system bus by a hard disk drive interface, a magnetic disk drive interface, and an optical disk drive interface, respectively. The drives and their associated computer-readable media provide nonvolatile storage of computer-readable instructions; data structures, e.g., a catalog and a context-based index; program modules, e.g., a web service and an indexing robot; and other data for the computer. It should be appreciated by those skilled in the art that any type of computer-readable media that can store data that is accessible by a computer, for example, magnetic cassettes, flash memory cards, digital video disks, RAM, and ROM, may be used in the exemplary operating environment.

A number of program modules may be stored on the hard disk, magnetic disk, optical disk, ROM, or RAM, including an operating system, one or more application programs, other program modules, and program data. A user may enter commands and information into the personal computer through input devices such as a keyboard and pointing device, for example, a mouse. Other input devices (not shown) may include, for example, a microphone, a joystick, a game pad, a tablet, a touch screen device, a satellite dish, a scanner, a facsimile machine, a video camera, a touch screen board as described above, single player wells, and an automated card reader. Input devices can also be individual player wells. These and other input devices are often connected to the processing unit through a serial port interface that is coupled to the system bus, but may be connected by other interfaces, such as a parallel port, game port or a universal serial bus (USB).

A monitor or other type of display device for embodiments of the invention may also be connected to the system bus via an interface, such as a video adapter. In addition to the monitor, computers typically include other peripheral output devices, such as a printers and speakers. These and other output devices are often connected to the processing unit through the serial port interface that is coupled to the system bus, but may be connected by other interfaces, such as a parallel port, game port, or a universal serial bus (USB).

The computer may operate in a networked environment using logical connections to one Or more remote computers. These logical connections may be achieved by a communication device coupled to or integral with the computer; the application is not limited to a particular type of communications device. The remote computer may be another computer, a server, a router, a network personal computer, a client, a peer device, or other common network node, and typically includes many or all of the elements described above relative to the computer, although only a memory storage device has been illustrated in FIG. 30. Computer can be logically connected to the internet. The logical connection can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

When used in a LAN environment, the computer may be connected to the local network through a network interface or adapter, which is one type of communications device. When used in a WAN environment, the computer typically includes a modem, a network adapter, or any other type of communications device for establishing communications over the wide area network. The modem, which may be internal or external, is connected to the system bus via the serial port interface. In a networked environment, program modules depicted relative to the personal computer, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

One skilled in the relevant art will appreciate that the computer system can include code that is loaded from a hard drive to be run on the processor. Alternatively, the system can be saved on a suitable storage medium such as a diskette, a CD, or like devices.

The system can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as web browsers, SOAP clients, JavaScript, Java Applets, instant messaging, e-mail, browser plug-ins, Macromedia Flash, chat and others. Other interactive hypertext environments may include environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Mozilla Firefox or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JavaScript or JAVA applets, for execution on the client computer. Finally, the WWW browser may include optional software components, called plug-ins, that run specialized functionality within the browser.

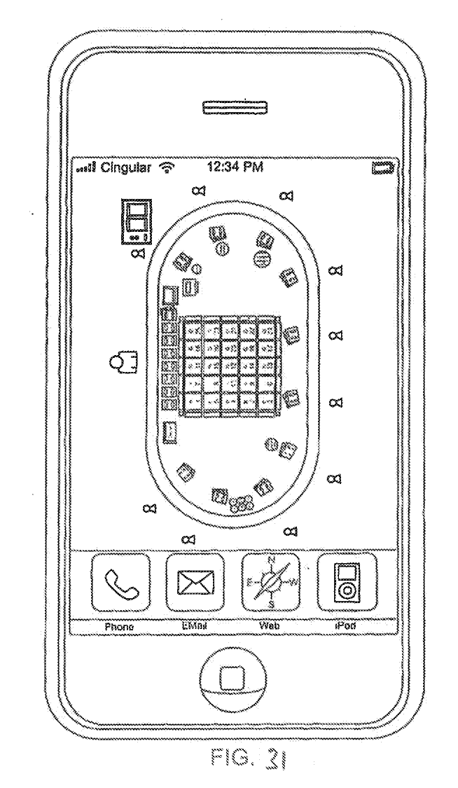

In other embodiments, games and methods described herein can be configured for play on a hand held device as shown in FIG. 31. As depicted, the device can be used to challenge other players on an online system.

It should be understood that a game according to the present invention may be incorporated in a fully or partially automated or interactive, computerized platform supporting multiple player positions. It should be readily apparent that additional computerized or manual systems may be employed in accordance with the present invention in order to achieve its full implementation.

Those skilled in the art will readily appreciate that the method described above may be incorporated in an electronic gaming machine or system in accordance with the invention. Such system or machine may include various computer and network related software and hardware, such as programs, operating systems, memory storage devices, input/output devices for data or monetary transfers, display devices, processors, servers with links to data communication systems, wireless or otherwise, and data transceiving terminals. Those skilled in the art will further appreciate that the precise types of software and hardware used are not vital to the full implementation of the present invention so long as players and operators of the present invention are provided with useful access thereto as described in exemplary embodiments herein.

While exemplary methods and applications of the methods of the present disclosure, have been described herein, it should also be understood that the foregoing is only illustrative of exemplary embodiments, as well as principles of the invention, and that various modifications can be made by those skilled in the art without departing from the scope and spirit of the invention. Therefore, the described embodiments should not be considered as limiting of the invention in any way. Accordingly, the invention embraces alternatives, modifications and variations which fall within the spirit and scope of the invention as described and claimed.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

Summary of Game Play for Baccarat Play with Full Color Gaming Cards of the Present Technology.

The gaming events in baccarat play according to the present technology using the novel 5-color playing card decks of the present invention. These card decks, as a reminder, include 55-card decks of five different color suits, with values running from one (1) through (11) eleven in equal probabilities. The playing cards are provided in randomized sets of at least one an up to ten (10) decks of fifty-five (55) cards.

The game cards, again in a player hand or a banker hand are dealt from the randomized set of playing cards, one card at a time to each of the hands. There is a unique methodology in the scoring of hands that is necessitated by the negative value contributions of one set or suit of playing cards. Scoring values in the progression of the total count for a hand are counted progressively (the first two cards are counted as a score of two, which is then maintained to be counted with the addition of the third card value). That is, if a +11 is dealt with a +3, the two-card count is +4. This is important and unique in the execution and mathematics of the game. This can be seen if a next card were to be a −5 value card. Using a progressive count according to the present requirements, the third card produces a value of (+4 and −5)−1. If the values were combined collectively, the final hand value would be +11 and +3 and −5, would collectively sum to +9. As can be seen, the methodology in always counting and solidifying count after delivery of intermediate numbers of cards (before an end of game count, such as +8 or +9 is reached).

There is also what is referred to as the “Spread Rule” that comes into play during the execution of the wagering event. This counting requirement comes into play when any hand has a negative count. Where the difference in total scores is within an absolute value of 11 (i.e., within ±11), the lower ranked score hand must take a card. That card can determine whether the lower-ranked hand can tie or win against the initially higher ranked/scored hand. For example, if the banker hand has a two-card hand score of −2 and the player hand has a two-card hand of +5, the spread between the hands is an absolute value of 7. This rule is in effect, and the Spread Rule overrides all other normal rules. If the next card has a negative value of −7, the round is a tie, if the next card is a −8, −9, −10 or −11, the player hand becomes in the lead with a third card score of −3, −4, −5 or −6, respectively. This third card hit then places at least one hand (now both hands) below zero (a negative total score) so that the Spread Rule remains in play, so that the Banker hand must then take an additional card. The additional cards continue as long as at least one hand count is below zero and the spread remains within the range of +11 (a range of absolute value 11). Once neither hand has a negative count, or if one or more hands has a negative count and the spread is greater than an absolute value of 11, the round of play ends, and the hands are compared according to game end rules to determine a win, loss or tie outcome between the banker and player hands.

The relative rank of hands, from lowest (42^{nd}) rank/score to highest (1^{st} and winning) rank/score is:

| | |
|---|---|
| 42 | 0 |
| 41 | 1 |
| 40 | 2 |
| 39 | 3 |
| 38 | 4 |
| 37 | 5 |
| 36 | 6 |
| 35 | 7 |
| 34 | 8 |
| 33 | 9 |
| 32 | −1 |
| 31 | −2 |
| 30 | −3 |
| 29 | −4 |
| 28 | −5 |
| 27 | −6 |
| 26 | −7 |
| 25 | −8 |
| 24 | −9 |
| 24 | −10 |
| 23 | −11 |
| 22 | −12 |
| 21 | −13 |
| 20 | −14 |
| 19 | −15 |
| 18 | −16 |
| 17 | −17 |
| 16 | −18 |
| 15 | −19 |
| 14 | −20 |
| 13 | −21 |
| 12 | −22 |
| 11 | −23 |
| 10 | −24 |
| 9 | −25 |
| 8 | −26 |
| 7 | −27 |
| 6 | −28 |
| 5 | −29 |
| 4 | −30 |
| 3 | −31 |
| 2 | −32 |
| 1 | −33 |

After the Spread Rule is not in effect, winning, losing and tying outcomes are determined according to the best (1, −33) score/rank to worst (42, 0) scores/ranks in the above table.

In the absence of the implementation of the Spread Rule, both hands (Player and Banker hand) operate with the same functional requirements.

On a two-card initial hand, any total point count of 0 to +5 must take a third card.

On a two-card initial hand, any total point count of +6 to +7 always stands.

On a two-card initial hand, any total point count of +8 to +9 ends the game. It must be remembered that these gaming control events do not operate if the relative point count of hands falls within the Spread Rule.

There are an unlimited number of side nets that may be used in the execution of the Full Color Baccarat™ gaming event. The side bets may be based on final scores, final winning spreads, total point counts in individual hands, winning hand with negative total in two cards, winning hand with negative total in three cards, winning hand has plus score in two cards and winning hand has plus score with three cards.

The total number of playing cards in a winning hand or in the collective hands may be wagered on as a side bet. A counting sequence in play could be as follows, with BOLD numbers indicating when the Spread Rule is in effect. The top sequence is the Banker hand and the lower sequence is the Player hand.

DEALER HAND

| | Card | | | | | | | | |
|---|---|---|---|---|---|---|---|---|---|
| | +2 +3 | −7 | +5 | +2 | −9 | +7 | −6 | +2 | +5 |
| Score | +5 | −2 | +3 | +5 | −4 | +3 | −3 | −1 | +4 |

PLAYER HAND

| | Card | | | | | | | | |
|---|---|---|---|---|---|---|---|---|---|
| | −2 +4 | +4 | −8 | −1 | +4 | −3 | +8 | +3 | +9 |
| Score | +2 | +6 | −2 | −3 | +1 | −2 | +6 | +9 | +8 |

The player hand wins with a final point count of +8 versus +4 for the Banker. As can be seen, that each hand ends with ten (10) playing cards. A wager may have been placed on how many cards are in a specific hand, or how many cards are in both hands.

Positive value hands are always valued as modulo 10 principles. That is, whenever an actual count or score of multiple playing cards has two digits (10-22 in positive values), the first digit is dropped, so there is only the last digit remaining as with 10→0, 11→1, 12→2 . . . 21→1 and 22→2. This is known and defined as modulo 10 counting according to the industry and the present invention.

The gaming technology includes both methods and systems. A method of initiating execution of a wagering event in a point count event using playing card symbols may include:
providing a set of randomized playing cards that includes five distinct sets of face-colored playing cards, each set having numeric values evenly distributed among the sets of 1, 2, 3, 4, 5, 6, 7, 8, 9, 10 and 11, with one of the five distinct sets valued as negative numeric values of −1, −2, −3, −4, −5, −6, −7, −8, −9, −10 and −11;
delivering two random playing cards from the set of randomized playing cards to each of a player position hand as an initial player position hand and a banker position hand as an initial banker position hand;
summing respective numeric values of the two cards in each of the player position hand and the banker position hand, including any negative numeric values;
determining if there is a concluding outcome in a comparison of respective summed numeric values in the player position hand and the banker position hand according to determination of whether a game ending condition exists of:
   a) at least one the initial player position hand and the initial banker position hand has a summed numeric value of less than zero and an absolute numeric value differentiation from the banker hand and player hand, respectively, of more than 11; or
   b) both the initial player position hand and the initial banker position hand have 0 or positive summed respective numeric values by modulo 10 counting and at least one of the initial player position hand and the initial banker position hand has a positive summed value of 8 or 9.

The set of randomized playing cards comprising five distinct sets of face-colored playing cards comprises at least one set of fifty-five playing cards comprising five colored sets of equal numbers of non-standard playing cards having number values of 1, 2, 3, 4, 5, 6, 7, 8, 9, 10 and 11, each colored set having different colors, and only one specific colored set having the negative numeric values.

The set of randomized playing cards comprises at least 4 of the five distinct sets of face colored playing cards. The faces of the playing cards may consist essentially of a background color, a number overlaying the background color indicating a value between 1, 2, 3, 4, 5, 6, 7, 8, 9, 10 and 11.

The method, if there is no concluding event according to a) or b), a third card is dealt to either of the player position hand and the banker position hand having:
c) a modulo point count between 0 and 5, and the respective banker position hand and player position hand has a modulo point count between 0 and 7.

The method, again if there is no concluding event according to a) or b), and at least one of the player hand and the banker hand has a negative numeric value total and there is an absolute summed value difference from the banker hand and player hand, respectively, that is less than 11, a third card is dealt to a lower ranked hand to form a three-card hand, the lower rank determined according to the following table, wherein rank counts are determined by decreasing rank moving from 1 to 42 as follows:

| Rank | count |
|---|---|
| 42 | 0 |
| 41 | 1 |
| 40 | 2 |
| 39 | 3 |
| 38 | 4 |
| 37 | 5 |
| 36 | 6 |
| 35 | 7 |
| 34 | 8 |
| 33 | 9 |
| 32 | −1 |
| 31 | −2 |
| 30 | −3 |
| 29 | −4 |
| 28 | −5 |
| 27 | −6 |
| 26 | −7 |
| 25 | −8 |
| 24 | −9 |
| 24 | −10 |
| 23 | −11 |
| 22 | −12 |
| 21 | −13 |
| 20 | −14 |
| 19 | −15 |
| 18 | −16 |
| 17 | −17 |
| 16 | −18 |
| 15 | −19 |
| 14 | −20 |
| 13 | −21 |
| 12 | −22 |
| 11 | −23 |
| 10 | −24 |
| 9 | −25 |
| 8 | −26 |
| 7 | −27 |
| 6 | −28 |
| 5 | −29 |
| 4 | −30 |
| 3 | −31 |
| 2 | −32 |
| 1 | −33 |

The method may have a concluding event that occurs after a three-card hand is formed by:
d) at least one three-card hand formed from the initial player position hand and the initial banker position hand has a summed numeric value of less than zero and an absolute numeric value differentiation from the banker hand and player hand, respectively, of more than 11; or
e) both the three-card hand formed from the initial player position hand or the initial banker position hand and the other respective hand have 0 or positive summed respective numeric values by modulo 10 counting and at least one of the three card hand formed from the initial player position hand or the initial banker position hand has a higher positive value than a respective other hand, or all hands have a same respective numeric value.

If there is still no concluding event according to d) or e), and at least one of the player hand and the banker hand has a negative numeric value total and there is an absolute summed value difference from the banker hand and player hand, respectively, that is less than 11, a fourth card is dealt to a lower ranked hand to form a three-card hand, the lower rank determined according to the following table, wherein rank counts are determined by decreasing rank moving from 1 to 42 as follows:

| Rank | count |
|---|---|
| 42 | 0 |
| 41 | 1 |
| 40 | 2 |
| 39 | 3 |
| 38 | 4 |
| 37 | 5 |
| 36 | 6 |
| 35 | 7 |
| 34 | 8 |
| 33 | 9 |
| 32 | −1 |
| 31 | −2 |
| 30 | −3 |
| 29 | −4 |
| 28 | −5 |
| 27 | −6 |
| 26 | −7 |
| 25 | −8 |
| 24 | −9 |
| 24 | −10 |
| 23 | −11 |
| 22 | −12 |
| 21 | −13 |
| 20 | −14 |
| 19 | −15 |
| 18 | −16 |
| 17 | −17 |
| 16 | −18 |
| 15 | −19 |
| 14 | −20 |
| 13 | −21 |
| 12 | −22 |
| 11 | −23 |
| 10 | −24 |
| 9 | −25 |
| 8 | −26 |
| 7 | −27 |
| 6 | −28 |
| 5 | −29 |
| 4 | −30 |
| 3 | −31 |
| 2 | −32 |
| 1 | −33 |

The method may include a side bet being placed at a player position that is dependent on a target result when a concluding event occurs.

A system for executing a variation of a baccarat wagering event on a physical gaming table may include:
a set of randomized physical playing cards comprising five distinct sets of face-colored playing cards, each set having numeric values evenly distributed among the sets of 1, 2, 3, 4, 5, 6, 7, 8, 9, 10 and 11, with one of the five distinct sets valued as negative numeric values of −1, −2, −3, −4, −5, −6, −7, −8, −9, −10 and −11;
a position on the gaming table indicating a location for a banker hand and a player hand to be dealt;
positions at multiple player positions for placing wagers at the individual player positions for determination in the baccarat wagering event, the wagers including at least a player win wager position, a dealer win wager position and a tie wager position;

and a side bet wager position where wagers are placed on a side bet where an outcome is determined by wagering on both how many playing cards are in a specified winning hand and whether that specified winning hand will have a winning outcome with exactly two physical playing cards or three playing cards, and whether or not the winning hand will have a positive total point count. For example, a player may wager on Banker hand, three cards (or two cards), negative value (or positive value); or Player hand, three cards (or two cards), positive value (or negative value). Payout outs on the wagers may exceed one-to-one and may differ among the different results.

The method may also be executed on an electronic gaming device such as by a method of executing a video baccarat wagering event in which a positive total point count outcome or a negative total point count outcome can occur in each of a banker hand and a player hand, the method being performed on an electronic gaming system including:
at least one player input device at a player position;
at least one display device;
at least one processor; and
at least one memory device which stores a plurality of instructions, which when executed by the at least one processor, cause the at least one processor to operate with the at least one input device and the at least one display device to:

after acceptance of a wager input by a player position on at least the video poker wagering event, the processor (a) executes play of a base game of video baccarat using a set of non-standard virtual card playing decks comprising:
(i) a set of randomized virtual playing cards having, for example, five distinct sets of face-colored playing cards, each set having numeric values evenly distributed among the sets of 1, 2, 3, 4, 5, 6, 7, 8, 9, 10 and 11, with one of the five distinct sets valued as negative numeric values of −1, −2, −3, −4, −5, −6, −7, −8, −9, −10 and −11;

(b) wherein exactly two virtual playing cards from the randomized virtual playing cards are virtually delivered to respective banker hand positions and player hand positions displayed on the at least one display device; and

(c) the processor makes a determination of whether a winning or losing or tying outcome has occurred after only the exactly two virtual playing cards from the randomized virtual playing cards are virtually delivered to respective banker hand positions and player hand positions displayed on the at least one display device.

The credits to be used for the wagers may be entered into the electronic gaming system through a value-in-value-out component selected from the group consisting of a currency validator with a currency scanner and currency-advancing motor, a ticket-in-ticket-out reader and printer combination, a magnetic or bar code reader accessible through an input opening, and an electronic wallet near-field communication reader.

What is claimed:

1. A method of initiating execution of a wagering event in a point count event using playing card symbols comprising:
providing a set of randomized playing cards comprising five distinct sets of face-colored playing cards, each set having numeric values evenly distributed among the sets of 1, 2, 3, 4, 5, 6, 7, 8, 9, 10 and 11, with one of the five distinct sets valued as negative numeric values of −1, −2, −3, −4, −5, −6, −7, −8, −9, −10 and −11;
delivering two random playing cards from the set of randomized playing cards to each of a player position hand as an initial player position hand and a banker position hand as an initial banker position hand;
summing respective numeric values of the two cards in each of the player position hand and the banker position hand, including any negative numeric values;
determining if there is a concluding outcome in a comparison of respective summed numeric values in the player position hand and the banker position hand according to determination of whether a game ending condition exists of:
f) at least one the initial player position hand and the initial banker position hand has a summed numeric value of less than zero and an absolute numeric value differentiation from the banker hand and player hand, respectively, of more than 11; or
g) both the initial player position hand and the initial banker position hand have 0 or positive summed respective numeric values by modulo 10 counting and at least one of the initial player position hand and the initial banker position hand has a positive summed value of 8 or 9.

2. The method of claim 1 wherein the set of randomized playing cards comprising five distinct sets of face-colored playing cards comprises at least one set of fifty-five playing cards comprising five colored sets of equal numbers of non-standard playing cards having number values of 1, 2, 3, 4, 5, 6, 7, 8, 9, 10 and 11, each colored set having different colors, and only one specific colored set having the negative numeric values.

3. The method of claim 2 wherein the set of randomized playing cards comprises at least 4 of the five distinct sets of face colored playing cards.

4. The method of claim 3 wherein the faces of the playing cards consist essentially of a background color, a number overlaying the background color indicating a value between 1, 2, 3, 4, 5, 6, 7, 8, 9, 10 and 11.

5. The method of claim 1 wherein if there is no concluding event according to a) or b), a third card is dealt to either of the player position hand and the banker position hand having:
h) a modulo point count between 0 and 5, and the respective banker position hand and player position hand has a modulo point count between 0 and 7.

6. The method of claim 1 wherein if there is no concluding event according to a) or b), and at least one of the player hand and the banker hand has a negative numeric value total and there is an absolute summed value difference from the banker hand and player hand, respectively, that is less than 11, a third card is dealt to a lower ranked hand to form a three-card hand, the lower rank determined according to the following table, wherein rank counts are determined by decreasing rank moving from 1 to 42 as follows:

| Rank | count |
|---|---|
| 42 | 0 |
| 41 | 1 |
| 40 | 2 |
| 39 | 3 |
| 38 | 4 |
| 37 | 5 |
| 36 | 6 |
| 35 | 7 |
| 34 | 8 |
| 33 | 9 |
| 32 | −1 |
| 31 | −2 |
| 30 | −3 |
| 29 | −4 |
| 28 | −5 |
| 27 | −6 |
| 26 | −7 |
| 25 | −8 |
| 24 | −9 |
| 24 | −10 |
| 23 | −11 |
| 22 | −12 |
| 21 | −13 |
| 20 | −14 |
| 19 | −15 |
| 18 | −16 |
| 17 | −17 |
| 16 | −18 |
| 15 | −19 |
| 14 | −20 |
| 13 | −21 |
| 12 | −22 |
| 11 | −23 |
| 10 | −24 |
| 9 | −25 |
| 8 | −26 |
| 7 | −27 |
| 6 | −28 |
| 5 | −29 |
| 4 | −30 |
| 3 | −31 |
| 2 | −32 |
| 1 | −33 |

7. The method of claim 6, wherein a concluding event occurs after a three-card hand is formed by:
i) at least one three-card hand formed from the initial player position hand and the initial banker position hand has a summed numeric value of less than zero and an absolute numeric value differentiation from the banker hand and player hand, respectively, of more than 11; or
j) both the three-card hand formed from the initial player position hand or the initial banker position hand and the other respective hand have 0 or positive summed respective numeric values by modulo 10 counting and at least one of the three card hand formed from the initial player position hand or the initial banker position hand has a higher positive value than a respective other hand, or all hands have a same respective numeric value.

8. The method of claim 7, wherein if there is no concluding event according to d) or e), and at least one of the player hand and the banker hand has a negative numeric value total and there is an absolute summed value difference from the banker hand and player hand, respectively, that is less than 11, a fourth card is dealt to a lower ranked hand to form a three-card hand, the lower rank determined according to the following table, wherein rank counts are determined by decreasing rank moving from 1 to 42 as follows:

| Rank | count |
|---|---|
| 42 | 0 |
| 41 | 1 |
| 40 | 2 |
| 39 | 3 |
| 38 | 4 |
| 37 | 5 |
| 36 | 6 |
| 35 | 7 |
| 34 | 8 |
| 33 | 9 |
| 32 | −1 |
| 31 | −2 |
| 30 | −3 |
| 29 | −4 |
| 28 | −5 |
| 27 | −6 |
| 26 | −7 |
| 25 | −8 |
| 24 | −9 |
| 24 | −10 |
| 23 | −11 |
| 22 | −12 |
| 21 | −13 |
| 20 | −14 |
| 19 | −15 |
| 18 | −16 |
| 17 | −17 |
| 16 | −18 |
| 15 | −19 |
| 14 | −20 |
| 13 | −21 |
| 12 | −22 |
| 11 | −23 |
| 10 | −24 |
| 9 | −25 |
| 8 | −26 |
| 7 | −27 |
| 6 | −28 |
| 5 | −29 |
| 4 | −30 |
| 3 | −31 |
| 2 | −32 |
| 1 | −33 |

9. The method of claim 6 wherein if there is no concluding event according to e), a fourth card a lower ranked hand to form a three-card hand, the lower rank determined according to the following table, wherein rank counts are determined by decreasing rank moving from 1 to 42 as follows:

| Rank | count |
|---|---|
| 42 | 0 |
| 41 | 1 |
| 40 | 2 |
| 39 | 3 |
| 38 | 4 |
| 37 | 5 |
| 36 | 6 |
| 35 | 7 |
| 34 | 8 |
| 33 | 9 |
| 32 | −1 |
| 31 | −2 |
| 30 | −3 |
| 29 | −4 |
| 28 | −5 |
| 27 | −6 |
| 26 | −7 |
| 25 | −8 |
| 24 | −9 |
| 24 | −10 |
| 23 | −11 |
| 22 | −12 |
| 21 | −13 |
| 20 | −14 |
| 19 | −15 |
| 18 | −16 |
| 17 | −17 |
| 16 | −18 |
| 15 | −19 |
| 14 | −20 |
| 13 | −21 |
| 12 | −22 |
| 11 | −23 |
| 10 | −24 |
| 9 | −25 |
| 8 | −26 |
| 7 | −27 |
| 6 | −28 |
| 5 | −29 |
| 4 | −30 |
| 3 | −31 |
| 2 | −32 |
| 1 | −33 |

10. The method of claim 1 wherein a side bet is placed at a player position that is dependent on a target result when a concluding event occurs.

11. The method of claim 2 wherein a side bet is placed at a player position that is dependent on a target result when a concluding event occurs.

12. The method of claim 3 wherein a side bet is placed at a player position that is dependent on a target result when a concluding event occurs.

13. The method of claim 4 wherein a side bet is placed at a player position that is dependent on a target result when a concluding event occurs.

14. The method of claim 6 wherein a side bet is placed at a player position that is dependent on a target result when a concluding event occurs.

15. The method of claim 7 wherein a side bet is placed at a player position that is dependent on a target result when a concluding event occurs.

16. The method of claim 8 wherein a side bet is placed at a player position that is dependent on a target result when a concluding event occurs.

17. The method of claim 9 wherein a side bet is placed at a player position that is dependent on a target result when a concluding event occurs.

18. A system for executing a variation of a baccarat wagering event on a physical gaming table comprising:
a set of randomized physical playing cards comprising five distinct sets of face-colored playing cards, each set having numeric values evenly distributed among the sets of 1, 2, 3, 4, 5, 6, 7, 8, 9, 10 and 11, with one of the five distinct sets valued as negative numeric values of −1, −2, −3, −4, −5, −6, −7, −8, −9, −10 and −11;
a position on the gaming table indicating a location for a banker hand and a player hand to be dealt;
positions at multiple player positions for placing wagers at the individual player positions for determination in the baccarat wagering event, the wagers including at least a player win wager position, a dealer win wager position and a tie wager position;
and a side bet wager position where wagers are placed on a side bet where an outcome is determined by wagering on both how many playing cards are in a specified winning hand and whether that specified winning hand will have a winning outcome with exactly two physical playing cards or three playing cards, and whether or not the winning hand will have a positive total point count.

19. A method of executing a video baccarat wagering event in which a positive total point count outcome or a negative total point count outcome can occur in each of a banker hand and a player hand, the method being performed on an electronic gaming system comprising:
at least one player input device at a player position;
at least one display device;
at least one processor; and
at least one memory device which stores a plurality of instructions, which when executed by the at least one processor, cause the at least one processor to operate with the at least one input device and the at least one display device to:
after acceptance of a wager input by a player position on at least the video poker wagering event, the processor (a) executes play of a base game of video baccarat using a set of non-standard virtual card playing decks comprising:
(i) a set of randomized virtual playing cards comprising five distinct sets of face-colored playing cards, each set having numeric values evenly distributed among the sets of 1, 2, 3, 4, 5, 6, 7, 8, 9, 10 and 11, with one of the five distinct sets valued as negative numeric values of −1, −2, −3, −4, −5, −6, −7, −8, −9, −10 and −11;
(b) wherein exactly two virtual playing cards from the randomized virtual playing cards are virtually delivered to respective banker hand positions and player hand positions displayed on the at least one display device; and
(c) the processor makes a determination of whether a winning or losing or tying outcome has occurred after only the exactly two virtual playing cards from the randomized virtual playing cards are virtually delivered to respective banker hand positions and player hand positions displayed on the at least one display device.

20. The method of claim 19 wherein credits to be used for the wagers are entered into the electronic gaming system through a value-in-value-out component selected from the group consisting of a currency validator with a currency scanner and currency-advancing motor, a ticket-in-ticket-out reader and printer combination, a magnetic or bar code reader accessible through an input opening, and an electronic wallet near-field communication reader.
